(19) United States
(12) Patent Application Publication
(10) Pub. No.: US 2013/0293735 A1
(43) Pub. Date: Nov. 7, 2013

(54) IMAGING CONTROL DEVICE, IMAGING APPARATUS, AND CONTROL METHOD FOR IMAGING CONTROL DEVICE

(71) Applicant: Sony Corporation, (US)

(72) Inventor: Hironori Suzaki, Kanagawa (JP)

(73) Assignee: Sony Corporation, Tokyo (JP)

(21) Appl. No.: 13/661,600

(22) Filed: Oct. 26, 2012

(30) Foreign Application Priority Data
Nov. 4, 2011 (JP) 2011-241823

(51) Int. Cl. H04N 5/225

(52) U.S. Cl. CPC H04N 5/225
USPC 348/222.1

(57) ABSTRACT

An imaging control device includes a character recognition section, an object recognition section, an imaging condition determination section, and an imaging control section. The character recognition section is configured to recognize a predetermined character string in an image to be imaged, and the object recognition section is configured to recognize a predetermined object in the image. The imaging condition determination section is configured to determine an imaging condition for imaging of the image, the imaging condition being determined based on the recognized character string and the recognized object. The imaging control section is configured to control the imaging of the image in accordance with the determined imaging condition.

### CROSS-REFERENCE TO RELATED APPLICATION

The present application claims priority from Japanese Patent Application No. JP 2011-241823 filed in the Japanese Patent Office on Nov. 4, 2011, the entire content of which is incorporated herein by reference.

### BACKGROUND

The present technology relates to an imaging control device, an imaging apparatus, and a control method for the imaging control device and, more specifically, to an imaging control device, an imaging apparatus, and a control method for the imaging control device with which conditions for imaging are determined.

### SUMMARY

A recently popular imaging apparatus is with the function of identifying in which scene or situation imaging is to be performed (hereinafter, the scene or situation as such is referred to as “imaging scene”), and the function of setting imaging conditions considering the identified imaging scene. The imaging scene being an identification target includes landscape and nightscape, for example, and the imaging conditions to be set include the F value, the ISO sensitivity, the white balance, and others. To identify such a target imaging scene, image data is often subjected to calculation of features. As an example, Japanese Patent Application Laid-open No. 2004-62605 describes a scene identifying apparatus that calculates features of image data. The features include an average pixel value, coefficients in the distribution function of pixel values, and others. This scene identifying apparatus uses the calculated features to identify an imaging scene. That is, when an average brightness value is smaller than a threshold value, the scene identifying apparatus identifies that the scene for imaging is nightscape, for example. Thereafter, by taking thus identified imaging scene into consideration, the imaging apparatus sets conditions for imaging of the scene. That is, for the nightscape scene, the imaging conditions are to be set with higher exposure, for example.

The issue here is that, with the previous technology described above, the imaging conditions set thereby may not be appropriate. This is because the imaging scene identified by the imaging apparatus may not be correctly the actual imaging scene. As an example, at a wedding ceremony, imaging may be performed in a scene when the room is temporarily darkened, e.g., when the bride enters or leaves the room. When the bride enters or leaves the room as such, the imaging apparatus may identify the imaging scene as nightscape because the average brightness value is small in the image, and may thus set the exposure high. However, if the exposure is high for imaging of the scene when the bride enters or leaves the room at the wedding ceremony, due to overexposure, this may affect the gray scale in the white portion of a wedding gown or/and a wedding cake, i.e., may cause so-called “whiteout”. As such, because the imaging scene identified by the imaging apparatus may not be correctly the actual imaging scene, there thus is a problem that the imaging conditions set thereby may not be appropriate.

It is thus desirable to provide an imaging apparatus with which conditions for imaging are appropriately set.

According to a first embodiment of the present technology, there are provided an imaging control device, and a control method therefor. The imaging control device includes a character recognition section, an object recognition section, an imaging condition determination section, and an imaging control section. The character recognition section is configured to recognize a predetermined character string in an image to be imaged. The object recognition section is configured to recognize a predetermined object in the image. The imaging condition determination section is configured to determine imaging conditions for imaging of the image, the imaging conditions being determined based on the recognized character string and the recognized object. The imaging control section is configured to control the imaging of the image in accordance with the determined imaging conditions. With such an imaging control device and a method therefor, the image conditions are favorably determined based on the recognized character string and the recognized object.

In the first embodiment, the imaging condition determination section may include a character scene identification section configured to identify an imaging scene from the recognized character string, and a character scene imaging condition determination section configured to determine the imaging conditions, the imaging conditions being determined based on the identified imaging scene, and the recognized object. With this configuration, the imaging conditions are favorably determined based on the identified imaging scene, and the recognized object.

Also in the first embodiment, the imaging condition determination section may further include a character scene identification database in which each candidate for the imaging scene is correlated with a candidate character string relevant thereto. When any of the candidate character strings is recognized, the character scene identification section may identify that the candidate corresponding to the candidate character string is the imaging scene. With this configuration, the imaging scene is favorably identified from a plurality of candidates therefor each corresponding to a character string.

Also in the first embodiment, the imaging condition determination section may further include an imaging condition table in which each combination of the imaging scene and one of a plurality of objects relevant thereto is correlated with various imaging conditions. The character scene imaging condition determination section may select any of the imaging conditions corresponding to the combination of the identified imaging scene and the recognized object for use as the imaging conditions for the imaging of the image. With this configuration, the imaging conditions to be determined are favorably those corresponding to a combination of the imaging scene identified from various imaging conditions in the imaging condition table, and the recognized object.

Also in the first embodiment, when there are various imaging conditions corresponding to the combination, the character scene imaging condition determination section may wait for an operation of selecting any of the imaging conditions, the selected imaging conditions being determined as the imaging conditions for the imaging of the image. In this manner, the selected imaging conditions are favorably determined as the imaging conditions for imaging of the image.

Also in the first embodiment, when only one of the imaging conditions is corresponding to the combination, the character scene imaging condition determination section may determine the imaging condition as the imaging conditions for the imaging of the image without waiting for the operation. In this manner, when there is only one imaging condition corresponding to the combination, the imaging condition is favorably determined without waiting for the user operation.

Also in the first embodiment, the imaging condition determination section may include a character scene imaging condition determination section, an image scene imaging condition determination section, and a for-use imaging condition determination section. The character scene imaging condition determination section is configured to determine character scene imaging conditions as the imaging conditions, the character scene imaging conditions being determined based on the recognized character string and the recognized object. The image scene imaging condition determination section is configured to determine image scene imaging conditions as the imaging conditions, the image scene imaging conditions being determined based on features, the features indicating a degree of predetermined features of the image in its entirety. The for-use imaging condition determination section is configured to determine, when the character string is recognized, the character scene imaging conditions as the imaging conditions for the imaging of the image, and when the character string is not recognized, determine the image scene imaging conditions as the imaging conditions for the imaging of the image. With this configuration, when the character string is recognized, favorably, the character scene imaging conditions are determined as the imaging conditions for use, and when no character string is recognized, the image scene imaging conditions are determined as the imaging conditions for use.

Also in the first embodiment, the for-use imaging condition determination section may determine, when the character string is recognized, the character scene imaging conditions and the image scene imaging conditions as the imaging conditions for the imaging of the image. The imaging control section may control the imaging of the image based on both of the character scene imaging conditions and the image scene imaging conditions. In this manner, when the character scene is recognized, both the character scene image conditions and the image scene imaging conditions are favorably determined as the imaging conditions for use.

Also in the first embodiment, when the character string is recognized, and when the present time is not within a predetermined time range, the for-use imaging condition determination section may determine the character scene imaging conditions and the image scene imaging conditions as the imaging conditions for the imaging of the image, and the imaging control section may control the imaging of the image based on both the character scene imaging conditions and the image scene imaging conditions. In this manner, when the character string is recognized, and when the present time is not within a predetermined time range, both the character scene imaging conditions and the image scene imaging conditions are favorably determined as the imaging conditions for use.

Also in the first embodiment, when the character string is recognized, and when the combination of the character scene imaging conditions and the image scene imaging conditions shows a matching with a specific combination, the for-use imaging condition determination section may determine the character scene imaging conditions and the image scene imaging conditions as the imaging conditions for the imaging of the image. The imaging control section may control the imaging of the image based on both the character scene imaging conditions and the image scene imaging conditions. In this manner, when the character string is recognized, and when the combination of the character scene imaging conditions and the image scene imaging conditions shows a matching with a specific combination, the character scene imaging conditions and the image scene imaging conditions are both favorably determined as the imaging conditions for use.

Also in the first embodiment, when the imaging of the image is performed in accordance with both the character scene imaging conditions and the image scene imaging conditions, in accordance with an operation of selecting the imaging conditions, the for-use imaging condition determination section may determine either the character scene imaging conditions or the image scene imaging conditions as the imaging conditions for imaging of an image subsequent to the image. As such, when the imaging of the image is performed in accordance with both the character scene imaging conditions and the image scene imaging conditions, in response to the user operation, either the character scene imaging conditions or the image scene imaging conditions are favorably determined as the imaging conditions for use.

According to a second embodiment of the present technology, there is provided an imaging apparatus. The imaging apparatus includes an imaging control device, and an imaging section. The imaging control device includes a character recognition section configured to recognize a predetermined character string in an image to be imaged, an object recognition section configured to recognize a predetermined object in the image, an imaging condition determination section configured to determine imaging conditions for imaging of the image, the imaging conditions being determined based on the recognized character string and the recognized object, and an imaging control section configured to control the imaging of the image in accordance with the determined imaging conditions. The imaging section is configured to perform the imaging of the image in accordance with the control. With such an imaging apparatus, the imaging conditions are favorably determined based on the recognized character string, and the recognized object.

According to the embodiments of the present technology, the imaging apparatus produces excellent effects of appropriately determining the imaging conditions.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing an exemplary configuration of an imaging apparatus in a first embodiment;

FIG. 2 is a block diagram showing an exemplary configuration of an image processing section in the first embodiment;

FIG. 3 is a block diagram showing an exemplary configuration of an imaging control device in the first embodiment;

FIG. 4 is a diagram showing an exemplary configuration of a character scene identification database in the first embodiment;

FIG. 5 is a diagram showing an exemplary configuration of a character scene imaging condition table in the first embodiment;

FIG. 6 is a diagram showing exemplary values set to the F value and the ISO sensitivity in the first embodiment;

FIG. 7 is a diagram showing an exemplary configuration of an image scene imaging condition table in the first embodiment;

FIG. 8 is a flowchart of an exemplary operation of the imaging apparatus in the first embodiment;

FIG. 9 is a flowchart of an exemplary imaging condition determination process in the first embodiment;

FIG. 10 is a diagram showing an exemplary image of a character scene in the first embodiment;

FIG. 11 is a diagram showing an exemplary image of a plurality of character scenes in the first embodiment;

FIG. 12 is a flowchart of an exemplary imaging condition determination process in a modified example;

FIG. 13 is a block diagram showing an exemplary configuration of an imaging control device in a second embodiment;

FIG. 14 is a diagram showing an exemplary configuration of a character scene imaging condition table in the second embodiment;

FIG. 15 is a diagram showing an exemplary configuration of a scene matching determination table in the second embodiment;

FIG. 16 is an exemplary state transition diagram of the imaging control device in the second embodiment;

FIG. 17 is a flowchart of an exemplary operation of the imaging apparatus in the second embodiment;

FIG. 18 is a flowchart of an exemplary imaging condition determination process in the second embodiment;

FIG. 19 is a flowchart of an exemplary character scene imaging mode change determination process in the second embodiment;

FIG. 20 is a flowchart of an exemplary continuous shooting mode change determination process in the second embodiment;

FIG. 21 is a flowchart of an exemplary image scene imaging mode change determination process in the second embodiment;

FIG. 22 is a flowchart of an exemplary imaging process in the second embodiment;

FIG. 23 is a flowchart of an exemplary after-continuous shooting mode selection process in the second embodiment;

FIG. 24 is a diagram showing an exemplary image including a delete button in the second embodiment; and

FIG. 25 is a diagram showing an exemplary image after continuous shooting in the second embodiment.

### DETAILED DESCRIPTION OF EMBODIMENTS

Hereinafter, embodiments of the present technology (hereinafter, simply referred to as embodiments) will be described. The description is given in the following order.

1. First Embodiment (Example of determining imaging conditions based on character strings and objects)

2. Second Embodiment (Example of continuous shooting in accordance with character scene imaging conditions, and image scene imaging conditions)

### 1. First Embodiment

### [Exemplary Configuration of Imaging Apparatus]

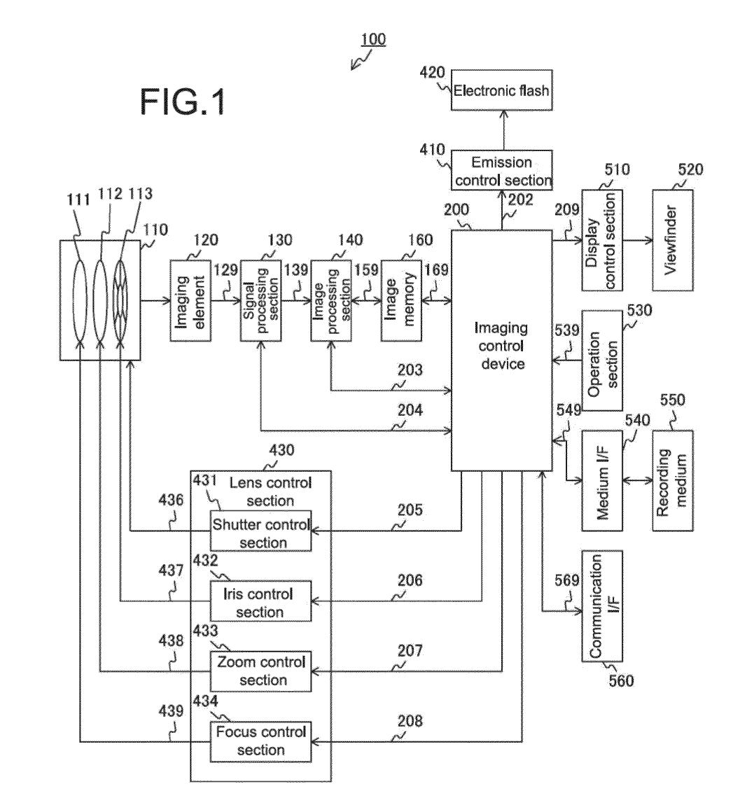

FIG. 1 is a block diagram showing an exemplary configuration of an imaging apparatus 100 in a first embodiment. The imaging apparatus 100 is for use of imaging, and includes an imaging lens 110, an imaging element 120, a signal processing section 130, an image processing section 140, and an image memory 160. The imaging apparatus 100 includes also an imaging control device 200, an emission control section 410, an electronic flash 420, a lens control section 430, a display control section 510, a viewfinder 520, an operation section 530, a medium interface 540, a recording medium 550, and a communication interface 560.

The imaging lens 110 forms the image of an imaging target on the imaging element 120, and is provided with a focus lens 111, a variator 112, and an aperture stop 113.

The focus lens 111 is a lens controllably positioned at the time of focusing. The variator 112 is a lens controllably positioned at the time of zooming. The aperture stop 113 is a shield member for adjusting the amount of light passing through the imaging lens 110. Note that, in the imaging apparatus 100, the imaging lens 110 in use is a zoom lens but a fixed focus lens is also an option as long as it forms an image on the imaging element 120.

The imaging element 120 subjects incoming light from the imaging lens 110 to photoelectric conversion, and outputs the resulting electric signal to the signal processing section 130 over a signal line 129. This imaging element 120 is implemented by a CCD (Charge Coupled Device), a CMOS (Complementary Metal Oxide Semiconductor) sensor, and others.

The signal processing section 130 performs a CDS (Correlated Double Sampling) process and an AGC (Automatic Gain Control) process on the electric signal provided by the imaging element 120. These processes are performed under the control of the imaging control device 200. The CDS process is for maintaining well a signal-to-noise ratio (S/N ratio), and the AGC process is for gain control. The signal processing section 130 subjects the signal obtained as such to A/D (Analog/Digital) conversion to form image data by the resulting digital signal, and then outputs the image data to the image processing section 140 over a signal line 139.

The image processing section 140 performs image processing on the image data provided by the signal processing section 130. The image processing is performed under the control of the imaging control device 200, and includes a white balance adjustment process, a color balance adjustment process, and others. After performing such various types of image processing, the image processing section 140 outputs the resulting image data to the image memory 160 over a signal line 159. The image memory 160 is for storage of the image data.

The imaging control device 200 determines imaging conditions for capturing the image data, and in accordance with the imaging conditions, controls the capturing of the image data. To be specific, the imaging control device 200 accesses the image memory 160 over a signal line 169 for reading of the image data, and recognizes what the image data includes, i.e., a character string(s) and an object(s). The imaging control device 200 also calculates the degree of features of the image data in its entirety, i.e., features. That is, the features to be calculated herein include statistics of pixel values, coefficients in the distribution function of pixel values, and others. The imaging control device 200 uses such information, i.e., the character string and the object, or the features, as a basis to determine the imaging conditions. How to determine the imaging conditions will be described in detail later. Upon reception of an operation signal asking for imaging from the operation section 530, the imaging control device 200 accordingly controls the other components, i.e., the image processing section 140, the emission control section 410, and the lens control section 430, to capture the image data in accordance with the imaging conditions determined as above. The image processing section 140 is controlled by a control signal provided over a signal line 203, and the lens control section 430 is controlled by a control signal provided by signal lines 205 to 208. The emission control section 410 is controlled by a control signal provided over a signal line 202.

The imaging control device 200 controls the display control section 510 via a signal line 209 to have various types of display data displayed by the viewfinder 520. This display data includes the image data, messages, and others. When the viewfinder 520 is a touch panel, the display data includes data for displaying buttons or others for use in touch operations. Further, the imaging control device 200 makes an access to the recording medium 550 via the medium interface 540 as appropriate to perform a process of writing or reading of the image data. The imaging control device 200 also transmits/receives data such as the image data via the communication interface 560.

The emission control section 410 is under the control of the imaging control device 200, and controls an emission operation of the electronic flash 420. The electronic flash 420 emits light at the time of imaging.

The lens control section 430 is under the control of the imaging control device 200, and controls the focal length of the imaging lens 110, and the amount of light, i.e., exposure, from the imaging lens 110 to the imaging element 120, for example. This lens control section 430 includes a shutter control section 431, an iris control section 432, a zoom control section 433, and a focus control section 434. The shutter control section 431 controls an open/close operation of a shutter over a signal line 436. The shutter is disposed between the imaging lens 110 and the imaging element 120. The iris control section 432 controls the F value of the aperture stop 113 over a signal line 437. The zoom control section 433 controls the focal length by controlling the position of the variator 112 over a signal line 438. The focus control section 434 controls the position of the focus lens 111 to come at the focal position over a signal line 439.

Note that these components, i.e., the imaging lens 110, the imaging element 120, the signal processing section 130, the image processing section 140, the image memory 160, and the lens control section 430, are an example of an imaging section claimed in Claims.

The display control section 510 controls the viewfinder 520 to have various types of display data displayed thereby. The viewfinder 520 is under the control of the display control section 510, and displays such display data.

The operation section 530 generates an operation signal in accordance with a user operation via the touch panel, the buttons, or others. The operation section 530 then outputs the operation signal to the imaging control device 200 over a signal line 539.

The medium interface 540 performs writing of the image data to the recording medium 550, and performs reading of the image data from the recording medium 550. The recording medium 550 for use is variously exemplified, including a so-called memory card using a semiconductor memory, an optical recording medium such as a recordable DVD (Digital Versatile Disk) and a recordable CD (Compact Disc), and a magnetic disk.

The communication interface 560 is for establishing communication between the imaging apparatus 100 and devices in the outside, e.g., information processing apparatus. During communication, the image data or others are transmitted/received therebetween.

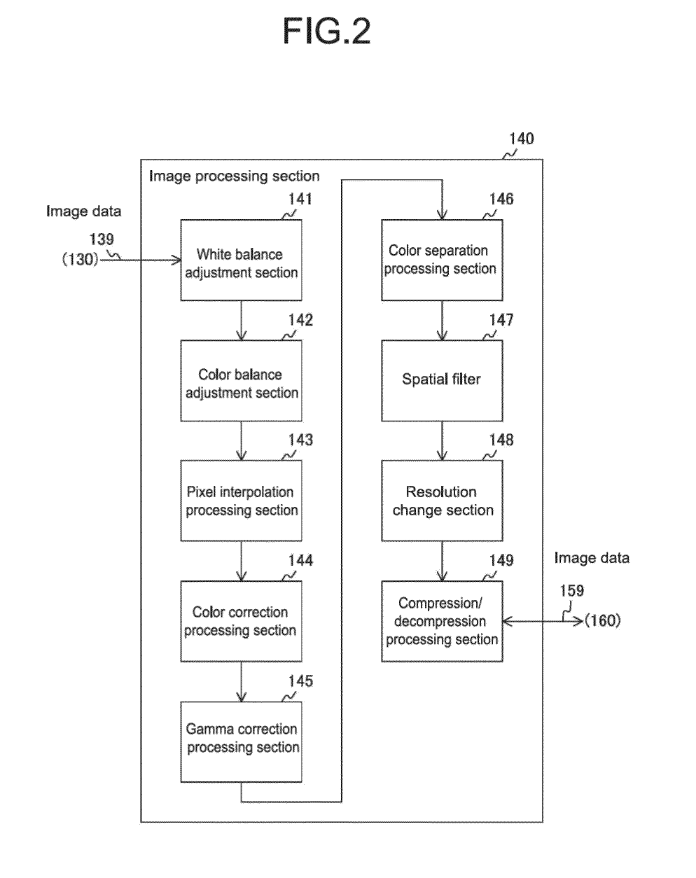

FIG. 2 is a block diagram showing an exemplary configuration of the image processing section 140 in the first embodiment. The image processing section 140 includes a white balance adjustment section 141, a color balance adjustment section 142, a pixel interpolation processing section 143, a color correction processing section 144, a gamma correction processing section 145, a color separation processing section 146, a spatial filter 147, and a resolution change section 148. The image processing section 140 is provided with a compression/decompression processing section 149.

The white balance adjustment section 141 makes a selection from various types of light sources, e.g., sunlight, or fluorescent lamp, and adjusts pixel values in the image data to correctly reproduce the white color under the selected light source. After the adjustment as such, the white balance adjustment section 141 outputs the resulting image data to the color balance adjustment section 142.

The color balance adjustment section 142 adjusts the balance of brightness and contrast for each hue such as RGB (Red-Green-Blue) in the image data. After the adjustment as such, the color balance adjustment section 142 outputs the resulting image data to the pixel interpolation processing section 143.

The pixel interpolation processing section 143 performs a demosaic process on image data, which includes only monochrome pixels. With the demosaic process, each pixel is interpolated with whichever color component it is missing. After the process as such, the pixel interpolation processing section 143 outputs the resulting image data to the color correction processing section 144.

The color correction processing section 144 performs a process on the image data to correct the pixel values on the basis of hue. After the process as such, the color correction processing section 144 outputs the resulting image data to the gamma correction processing section 145.

The gamma correction processing section 145 performs gamma correction on the image data in accordance with the characteristic of an input-output device. After the gamma correction, the gamma correction processing section 145 outputs the resulting image data to the color separation processing section 146.

The color separation processing section 146 performs a color separation process as appropriate for color space conversion on the image data. That is, the color space of RGB is converted into CMYK (Cyan-Magenta-Yellow-blacK) for example. After the color separation process, the color separation processing section 146 outputs the resulting image data to the spatial filter 147.

The spatial filter 147 performs a process of noise reduction or edge enhancement on the image data. The process uses a smoothing filter for noise reduction, a differential filter for edge enhancement, or others. After the process in the spatial filter 147, the resulting image data is output to the resolution change section 148.

The resolution change section 148 changes the resolution of the image data as appropriate. After the process, the resolution change section 148 outputs the resulting image data to the compression/decompression processing section 149.

The compression/decompression processing section 149 compresses or decompresses the image data as appropriate. This compression/decompression processing section 149 compresses the image data provided by the resolution change section 148 before output to the image memory 160, and decompresses the compressed image data in the image memory 160 for output back to the image memory 160.

Herein, the image processing section 140 performs image processing in order of white balance adjustment, color balance adjustment, pixel interpolation processing, color correction processing, gamma correction processing, processing in the spatial filter, resolution change processing, and compression/decompression processing. Alternatively, such image processing may be performed in any different order. Still alternatively, the image processing section 140 may perform any different image processing.

### [Exemplary Configuration of Imaging Control Device]

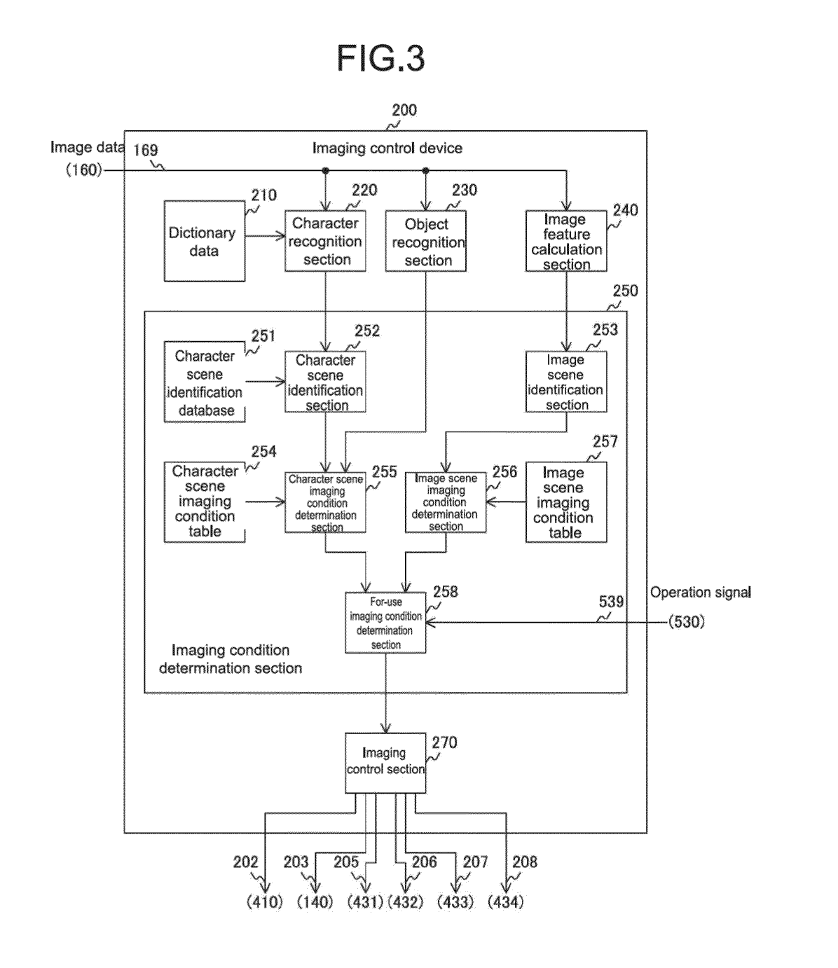

FIG. 3 is a block diagram showing an exemplary configuration of the imaging control device 200 in the first embodiment. The imaging control device 200 includes dictionary data 210, a character recognition section 220, an object recognition section 230, an image feature calculation section 240, an imaging condition determination section 250, and an imaging control section 270.

The dictionary data 210 includes data of standard patterns entered to each of recognition-target characters. The standard patterns are the quantification results of a statistical process performed on the shape patterns of the recognition-target characters.

The character recognition section 220 refers to the dictionary data 210 to recognize any character string in the image data to be captured. The character string to be recognized herein is the one consisting of predetermined characters. That is, the character recognition section 220 refers to the standard patterns entered in the dictionary data 210 to make a pattern matching with the shape pattern of a region estimated as a character in the image data, and extracts any of the standard patterns showing the best matching, for example. The character corresponding to the extracted standard pattern is the recognized character. The character recognition section 220 outputs a character string consisting of the recognized characters as such to the imaging condition determination section 250.

The object recognition section 230 recognizes a predetermined object in the image data to be captured. The recognition-target object is a human face, a dish of food, and others. The object recognition section 230 refers to standard patterns entered to the recognition-target objects to make a pattern matching with the shape pattern of a region estimated as an object in the image data, and extracts any of the standard patterns showing the best matching, for example. The object corresponding to the extracted standard pattern is the recognized object. The character recognition section 220 outputs data identifying the recognized object, i.e., data about title and identification number, to the imaging condition determination section 250.

The image feature calculation section 240 calculates the features, which indicate any predetermined characteristics of the image in its entirety. The features to be calculated herein include statistics of pixel values, coefficients in the distribution function of pixel values, and others in the image data. The image feature calculation section 240 outputs the calculated features to the imaging condition determination section 250.

The imaging condition determination section 250 determines imaging conditions for capturing the image data, and includes a character scene identification database 251, a character scene identification section 252, a character scene imaging condition table 254, and a character scene imaging condition determination section 255. The imaging condition determination section 250 is provided with an image scene identification section 253, an image scene imaging condition determination section 256, an image scene imaging condition table 257, and a for-use imaging condition determination section 258.

In the character scene identification database 251, identification-target imaging scenes each are correlated with character strings considered relevant thereto. Each of the imaging scenes correlated with the character strings as such is hereinafter referred to as “character scene”. This character scene is correlated with character strings assumed to be recognized in the character scene. That is, in a character scene of “wedding ceremony”, for example, character strings to be recognized may include “wedding ceremony”, “wedding party”, “marriage service”, and others. As such, for a character scene to be identified as a “wedding ceremony”, the character strings correlated thereto are these character strings.

The character scene identification section 252 uses the recognized character strings as a basis to identify a character scene. To be specific, the character scene identification section 252 determines whether at least one of the character strings in the character scene identification database 251 is recognized by the character recognition section 220 or not. When determining that one or more of the character strings are recognized thereby, the character scene identification section 252 outputs the character scene correlated with the character string(s) to the character scene imaging condition determination section 255 as the identified scene.

The character scene imaging condition table 254 is a table in which each combination of a character scene and one of a plurality of objects relevant thereto is correlated with various imaging conditions. The imaging conditions correlated with each combination of a character scene and an object as such are hereinafter referred to as “character scene imaging conditions”. Herein, the objects relevant to the character scene are objects that can be imaging subjects in the character scene. That is, at a wedding ceremony, imaging subjects may be objects such as a “wedding gown”, and “a dish of food”. As such, when these objects are expected to be imaged at the wedding ceremony, any imaging conditions considered appropriate for imaging of such subjects is correlated with both of a combination of the character scene of “wedding ceremony” and the object of “wedding gown”, and a combination of the character scene of “wedding ceremony” and the object of “dish of food”.

The character scene imaging condition determination section 255 determines the character scene imaging conditions based on the character scene. To be specific, the character scene imaging condition determination section 255 refers to the character scene imaging condition table 254 to read therefrom any character scene imaging conditions corresponding to the combination of the identified character scene and the recognized object. The character scene imaging conditions are thus determined as the imaging conditions obtained based on the character scene. The character scene imaging condition determination section 255 then outputs the character scene imaging conditions determined as such to the for-use imaging condition determination section 258.

The image scene identification section 253 uses the features of the entire image to identify an imaging scene. The imaging scene to be identified as such based on the features of the entire image is hereinafter referred to as “image scene”. The image scene identification section 253 learns in advance features of each identification-target image scene for reference use, e.g., nightscape, evening view, and beach. The image scene identification section 253 refers to the previously learned reference features as such for a comparison with the features calculated by the image feature calculation section 240, and extracts the reference features showing the best matching, e.g., the reference features with the smallest Euclidean distance. The image scene identification section 253 then outputs any of the image scenes corresponding to the extracted features to the image scene imaging condition determination section 256 as the identified scene.

Herein, the image scene identification section 253 identifies an imaging scene based on the features, but alternatively, may identify an imaging scene based on both the features and the object. That is, when the imaging scene identified based on the features is a landscape, and when a face is recognized as the object, the image scene identification section 253 identifies an imaging scene of a portrait as an image scene.

The image scene imaging condition table 257 is a table in which image scenes each are correlated with imaging conditions considered suitable therefor. The imaging conditions correlated to each of the image scenes are hereinafter referred to as “image scene imaging conditions”.

The image scene imaging condition determination section 256 determines the imaging conditions based on the image scene. To be specific, the image scene imaging condition determination section 256 refers to the image scene imaging condition table 257 to read therefrom any image scene imaging conditions corresponding to the image scene identified by the image scene identification section 253. The image scene imaging conditions are thus determined as the imaging conditions obtained based on the image scene. The image scene imaging condition determination section 256 then outputs the image scene imaging conditions determined as such to the for-use imaging condition determination section 258.

The for-use imaging condition determination section 258 determines which of the imaging conditions, i.e., the character scene imaging conditions and the image scene imaging conditions, are to be used for imaging. That is, the for-use imaging condition determination section 258 displays the character scenes corresponding to the recognized character string on the viewfinder 520, and waits for an operation signal for selection or confirmation thereof, for example. When any of the character scenes is selected or confirmed within a fixed length of time, e.g., within 10 seconds, the for-use imaging condition determination section 258 determines the character scene imaging conditions corresponding to the selected/confirmed character scene as the imaging conditions for use. When none of the character scenes is selected or confirmed within the fixed length of time, the for-use imaging condition determination section 258 determines the image scene imaging conditions as the imaging conditions for use. The for-use imaging condition determination section 258 then outputs the imaging conditions determined for use as such to the imaging control section 270.

Herein, the for-use imaging condition determination section 258 determines the imaging conditions based on an operation signal, but alternatively, may determine the imaging conditions without waiting for such an operation signal. That is, when any of the character scenes is identified, the for-use imaging condition determination section 258 may determine the character scene imaging conditions as the imaging conditions for use, and when no character scene is identified, may determine the image scene imaging conditions as the imaging conditions for use, for example.

The imaging control section 270 controls capturing of the image data in accordance with the imaging conditions determined for use as above. That is, the imaging control section 270 controls the other components, i.e., the emission control section 410, the image processing section 140, the shutter control section 431, the iris control section 432, the zoom control section 433, and the focus control section 434, for example. By such control, controlled are the emission operation of an electronic flash, the image processing, the shutter speed, the F value, the zoom magnification, and others.

Herein, the imaging control device 200 determines the image scene imaging conditions in addition to the character scene imaging conditions, but alternatively, may determine only the character scene imaging conditions. If this is the configuration, the imaging control device 200 is not necessarily provided with the image feature calculation section 240, the image scene identification section 253, the image scene imaging condition determination section 256, the image scene imaging condition table 257, and the for-use imaging condition determination section 258. In this configuration, the operation signal is input to the character scene imaging condition determination section 255, and in accordance with the operation signal, the character scene imaging condition determination section 255 determines the character scene imaging conditions.

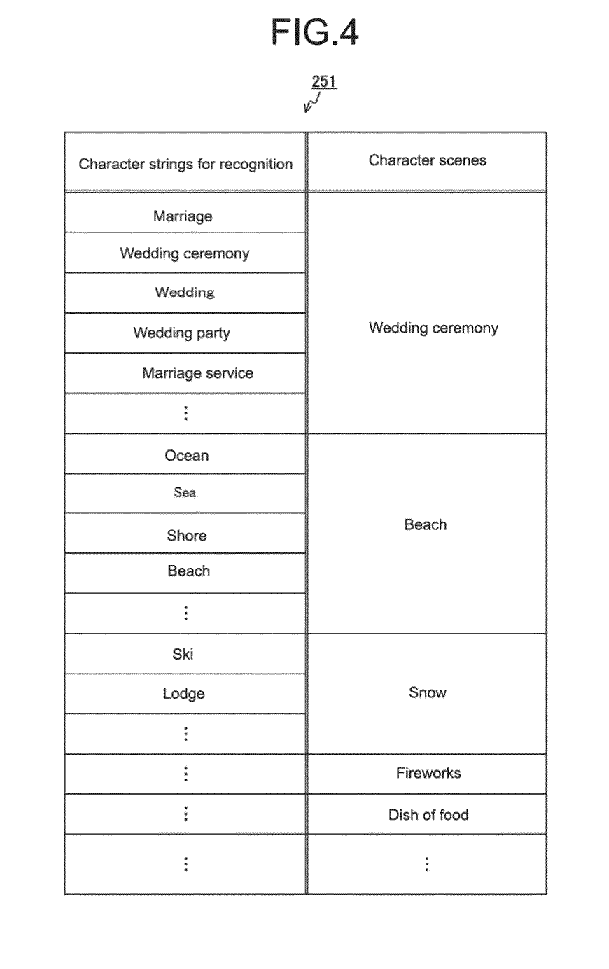

FIG. 4 is a diagram showing an exemplary configuration of the character scene identification database 251 in the first embodiment. In the character scene identification database 251, the character scenes each are correlated with character strings relevant thereto. That is, a character scene of “wedding ceremony” is correlated with character strings relevant thereto, e.g., “marriage”, “wedding ceremony”, and “Wedding”. Moreover, a character scene of “beach” is correlated with character strings relevant thereto, e.g., “ocean”, “Sea”, and “shore”.

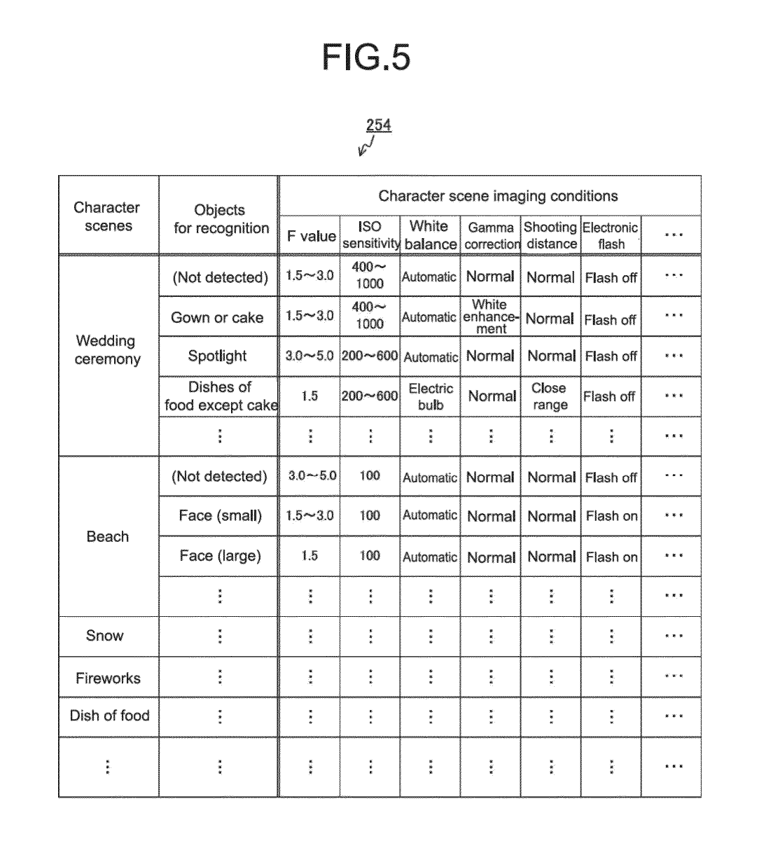

FIG. 5 is a diagram showing an exemplary configuration of the character scene imaging condition table 254 in the first embodiment. In the character scene imaging condition table 254, each combination of a character scene and one of a plurality of objects relevant thereto is correlated with various character scene imaging conditions. For example, a character scene of “wedding ceremony” is correlated with objects of “gown or cake”, “spotlight”, and others. The character scene imaging conditions include “F value”, “ISO sensitivity”, “white balance”, “gamma correction”, “shooting distance”, “electronic flash”, and others.

Herein, the columns of “F value” and “ISO sensitivity” each indicate the value range of adjustment with shutter speed priority AE (Auto Exposure). The F value and the ISO sensitivity each are set to fall within the value range in accordance with the user-set shutter speed to have the appropriate exposure.

As for the F value, when an imaging subject is a dish of food or a face, for example, a small value, e.g., 1.5, is set thereto to focus only on the imaging subject, in other words, to have the shallow depth of field. On the other hand, when no object is detected, a large value, e.g., in a range from 3.0 to 5.0, is set to the F value to have the deep depth of field.

As for the ISO sensitivity, when a character scene is “wedding ceremony”, because the wedding ceremony is often held indoors, a slightly large value, e.g., in a range from 400 to 1000, is set thereto with the aim of obtaining enough amount of light. When a character scene is beach, on the other hand, a small value, e.g., 100, is set to the ISO sensitivity because the direct sunlight is enough for the amount of light.

As for gamma correction, when an imaging subject is a wedding gown or a cake at a wedding ceremony, because the gown and the cake are often white in color, a value is set thereto to enhance the color of white, for example. As for the shooting distance, when imaging subjects are dishes of food except a wedding cake, because such dishes of food are often imaged at a close range, a macro shooting mode is set thereto. Moreover, as for the electronic flash, when an imaging subject is a face, a setting is so made that the electronic flash is forced to emit light with the aim of obtaining enough amount of light on the face.

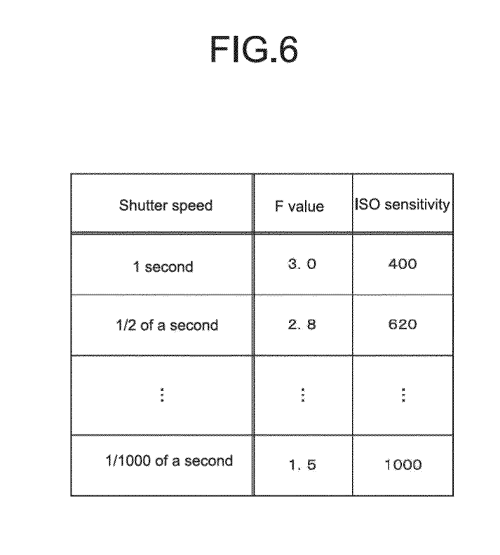

FIG. 6 shows setting examples of the F value and those of the ISO sensitivity when no object is detected in a character scene of “wedding ceremony” in FIG. 5. Herein, the exposure takes a larger value with a slower shutter speed, a smaller F value, and higher ISO sensitivity. Based on such a relationship, the F value and the ISO sensitivity are set in accordance with the shutter speed to have an appropriate value of exposure. When the shutter speed is slow, e.g., 1 second, the amount of light is to be enough, in other words, the exposure takes a large value even if the F value is large, and the ISO sensitivity is low. Therefore, the F value is set large, e.g., 3.0, and the ISO sensitivity is set low, e.g., 400. The F value and the ISO sensitivity as such may each take any value set in advance for every shutter speed, or may each be calculated by a fixed mathematical expression using the shutter speed.

Note here that, as an alternative to the shutter speed priority AE, aperture priority AE may be adopted, and a user-set F value may be used as a basis to set the shutter speed and the ISO sensitivity. Still alternatively, any of or all of the shutter speed, the F value, and the ISO sensitivity may be fixed in value.

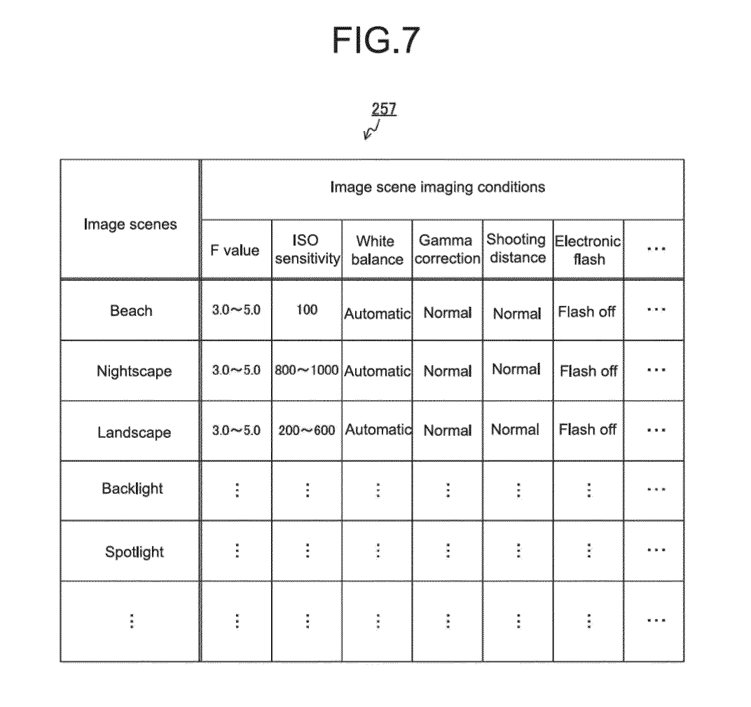

FIG. 7 is a diagram showing an exemplary configuration of the image scene imaging condition table 257 in the first embodiment. In the image scene imaging condition table 257, image scenes each are correlated with imaging conditions considered appropriate thereto as image scene imaging conditions.

### [Exemplary Operation of Imaging Apparatus]

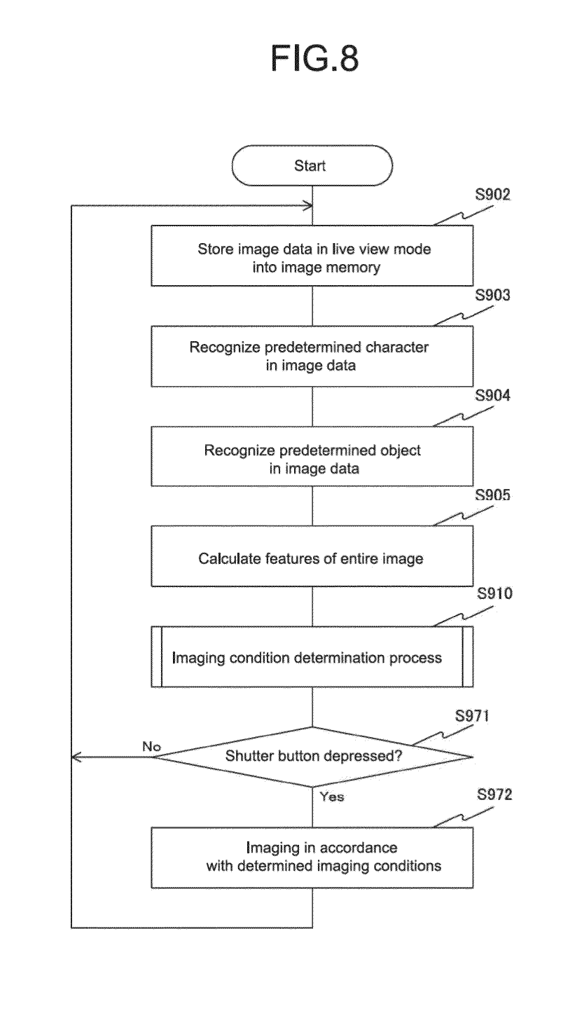

FIG. 8 is a flowchart of an exemplary operation of the imaging apparatus 100 in the first embodiment. This operation is started when the imaging apparatus 100 is changed to a so-called live view mode, for example. This live view mode is of displaying the image data from the imaging element 120 on the viewfinder 520 in real time. In this live view mode, the imaging apparatus 100 stores the image data in the image memory 160 (step S902). The imaging control device 200 in the imaging apparatus 100 then recognizes a predetermined character and a predetermined object in the image data (steps S903 and S904), thereby calculating features of the entire image (step S905). The imaging control device 200 performs an image condition determination process for determining the imaging conditions (step S910).

The imaging apparatus 100 then determines whether a shutter button is depressed or not (step S971). When determining that the shutter button is depressed (step S971: Yes), the imaging apparatus 100 captures the image data in accordance with the imaging conditions determined as above (step S972). When the imaging apparatus 100 determines that the shutter button is not depressed (step S971: No), or after step S972, the procedure returns to step S902.

### [Exemplary Operation of Imaging Control Device]

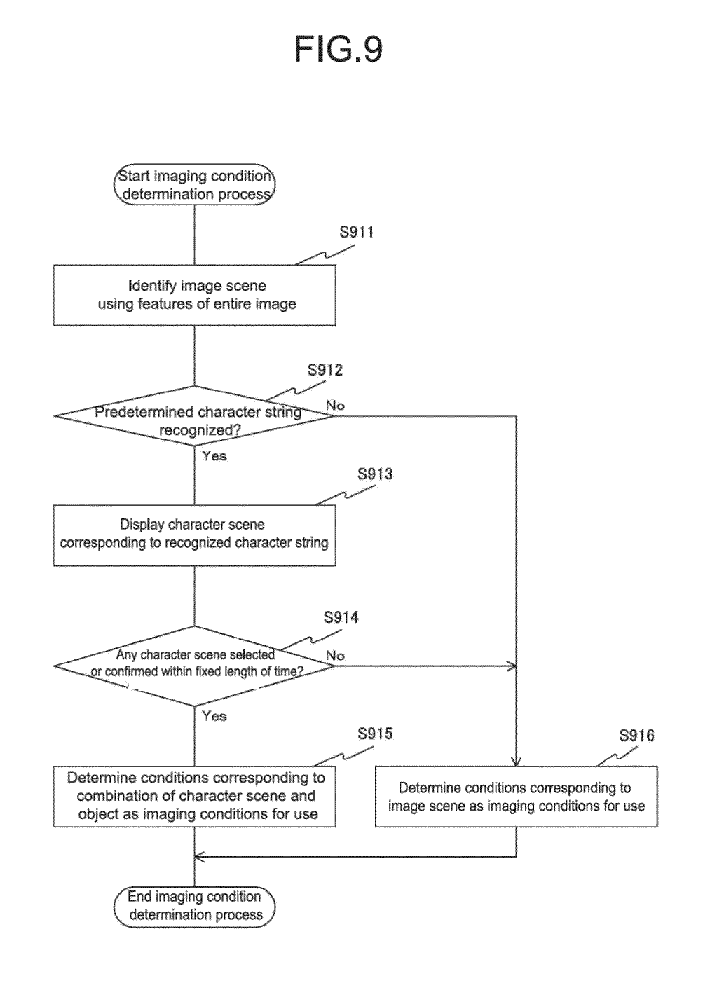

FIG. 9 is a flowchart of an exemplary imaging condition determination process in the first embodiment. The imaging control device 200 refers to the features of the entire image to identify an image scene (step S911). The imaging control device 200 then determines whether any predetermined character string in the character scene identification database 251 is recognized or not (step S912). When determining that the character string is recognized (step S912: Yes), the imaging control device 200 causes the viewfinder 520 to display the title of a character scene corresponding to the recognized character string. When a plurality of character scenes are found for the recognized character string, the imaging control device 200 waits for an operation of selecting any of these character scenes, and when only one character scene is found for the recognized character string, waits for an operation of confirming the character scene (step S913). The imaging control device 200 then determines whether any of the character scenes is selected or confirmed within a fixed length of time (step S914).

When determining that any of the character scenes is selected or confirmed within the fixed length of time (step S914: Yes), the imaging control device 200 then determines the character scene imaging conditions corresponding to a combination of the character scene and objects relevant thereto as imaging conditions (step S915). When determining that no character string is recognized (step S912: No), or when determining that none of the character scenes is selected or confirmed within the fixed length of time (step S914: No), the imaging control device 200 determines the image scene imaging conditions as imaging conditions for use (step S916). After step S915 or S916, this is the end of the imaging condition determination process.

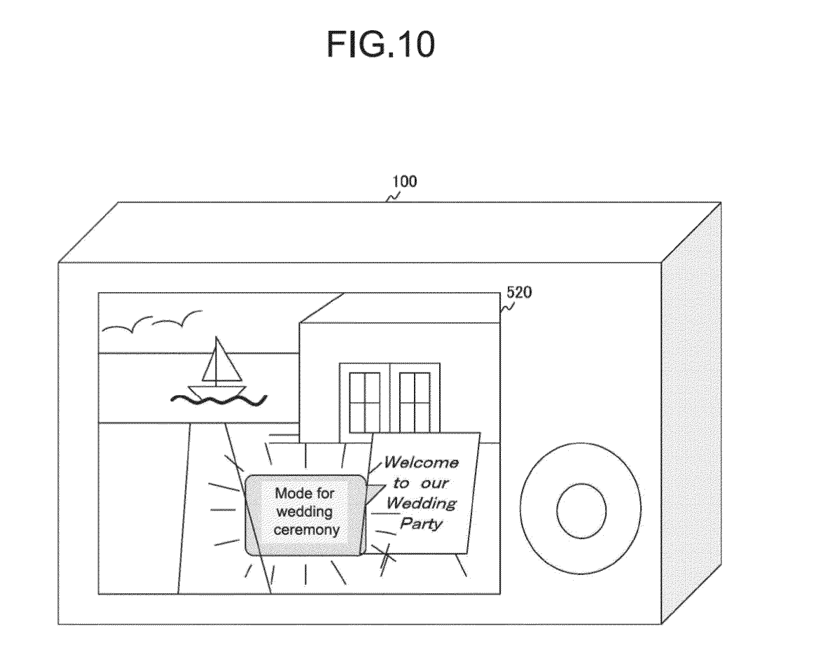

FIG. 10 is a diagram showing an exemplary image on the viewfinder 520 including a character scene in the first embodiment. The image data of the image includes a character string of “Wedding”. When the character string of “Wedding” is correlated with a wedding ceremony in the character scene identification database 251, the imaging apparatus 100 accordingly displays a character scene of “wedding ceremony”. Thereafter, when an operation is made to confirm this character scene within the fixed length of time, the imaging apparatus 100 performs imaging with the character scene imaging conditions for the wedding ceremony, and objects relevant thereto.

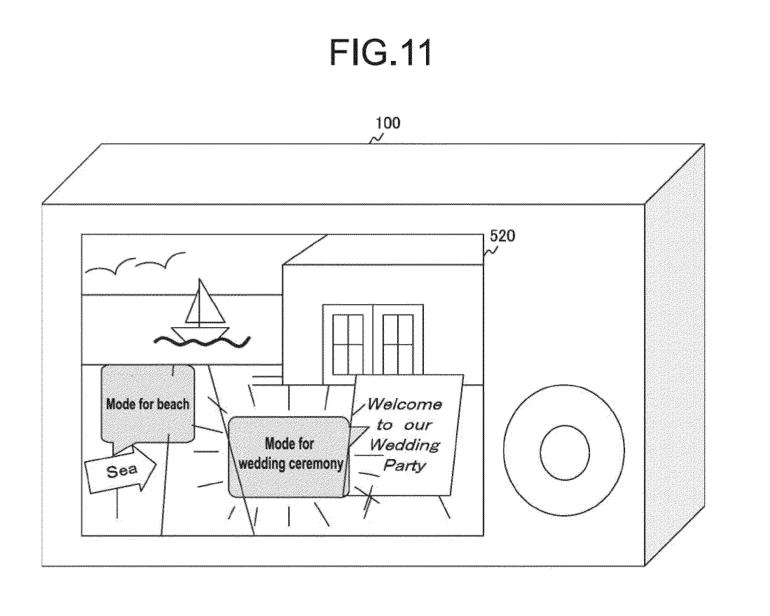

FIG. 11 is a diagram showing an exemplary image of a plurality of character scenes in the first embodiment. The image data of this image includes character strings of “Wedding” and “Sea”. When the character strings of “Wedding” and “Sea” are respectively correlated with wedding ceremony and beach in the character scene identification database 251, the imaging apparatus 100 accordingly displays a character scene of wedding ceremony and a character scene of beach. Thereafter, when an operation is made to select either one of these character scenes within the fixed length of time, the imaging apparatus 100 performs imaging with the character scene imaging conditions for the selected character scene, and objects relevant thereto.

Note that, when there are a plurality of character scenes, the imaging apparatus 100 produces a display to prompt a user to select any of the character scenes. Moreover, when there are various imaging conditions for a character scene and objects relevant thereto, the imaging apparatus 100 may more specifically produce a display to prompt the user to select any of the imaging conditions.

As such, according to the first embodiment of the present technology, the imaging control device 200 recognizes a predetermined character string and a predetermined object in an image to be imaged, and based on the recognition results of the character string and the object, determines the imaging conditions. In this manner, the character string and the object both recognized in the image are used to identify an imaging scene so that any appropriate imaging conditions are determined for the imaging scene. Accordingly, even if the features of an image are not enough to identify an imaging scene, the imaging apparatus 100 appropriately determines the imaging conditions.

Assumed herein is a case where shooting is performed at a wedding ceremony when the room is temporarily darkened, e.g., when the bride enters or leaves the room. In this case, when an imaging apparatus in use refers only to the features of an image to identify an imaging scene, because the average brightness value is small in the image, the imaging apparatus may identify that the scene for imaging is nightscape. However, if imaging is performed in accordance with imaging conditions for the imaging scene of nightscape, due to overexposure, a phenomenon of whiteout may occur in the portion of a wedding gown, for example. On the other hand, the imaging control device 200 refers to a character string such as “Wedding” or others to identify a character scene of wedding ceremony, and then performs imaging with reduced exposure, and with gamma correction of white enhancement in accordance with imaging conditions for a combination of the character scene of wedding ceremony and an object of gown or others. Accordingly, the imaging conditions are appropriately determined, and the phenomenon of whiteout is prevented from occurring.

### Modified Example

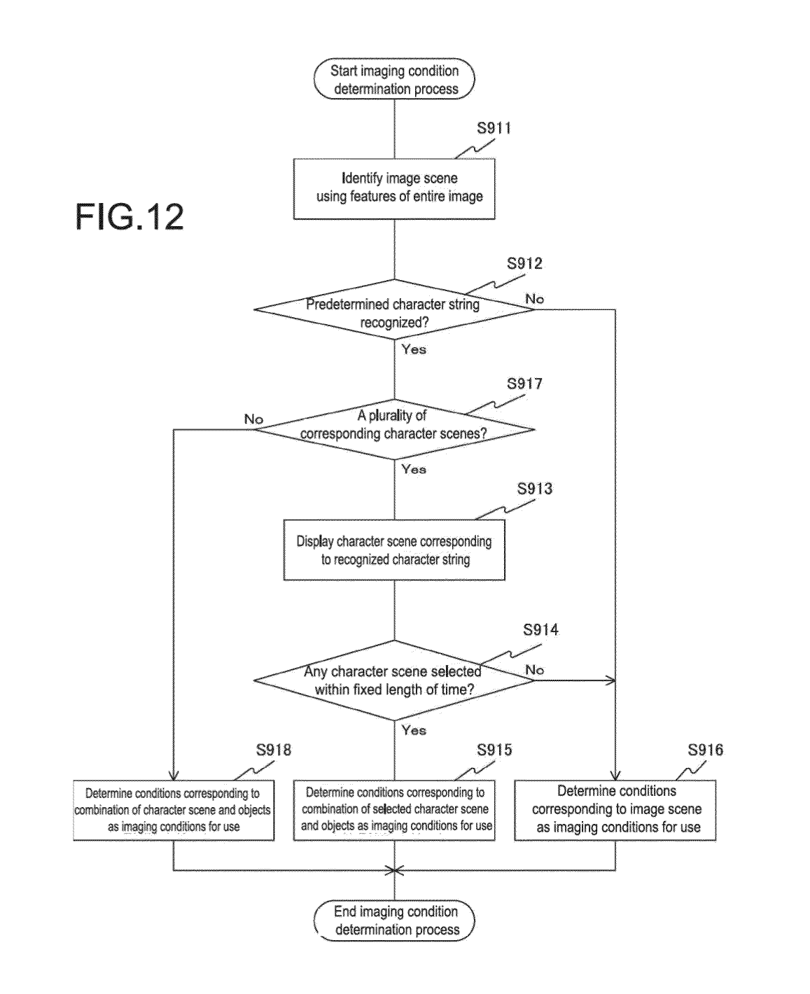

By referring to FIG. 12, described next is a modified example in the first embodiment of the present technology. FIG. 12 is a flowchart of an exemplary imaging condition determination process in the modified example of the first embodiment. Compared with the imaging condition determination process exemplarily shown in FIG. 9, in the imaging condition determination process in the modified example, when there is only one character scene corresponding to a specific character string, the character scene imaging conditions for the character scene are determined as imaging conditions for use without waiting for a user operation. To be specific, when determining that a predetermined character string is recognized (step S912: Yes), the imaging control device 200 determines whether there are a plurality of character scenes corresponding thereto (step S917). When determining that there is only one character scene (step S917: No), the imaging control device 200 determines the character scene imaging conditions corresponding to the character scene and objects relevant thereto as the imaging conditions for use (step S918). After step S918, this is the end of the imaging condition determination process. When determining that there are a plurality of character scenes (step S917: Yes), the imaging control device 200 displays any of the character scenes corresponding to the recognized character string (step S913). The processes after step S913 in the modified example are similar to those in the first embodiment.

According to the modified example as such, when there is only one character scene, the imaging conditions are determined without waiting for a confirmation operation, for example. Therefore, when there is only one character scene, the user is not expected to make a confirmation operation so that the user finds it convenient.

### 2. Second Embodiment

### [Exemplary Configuration of Imaging Control Device]

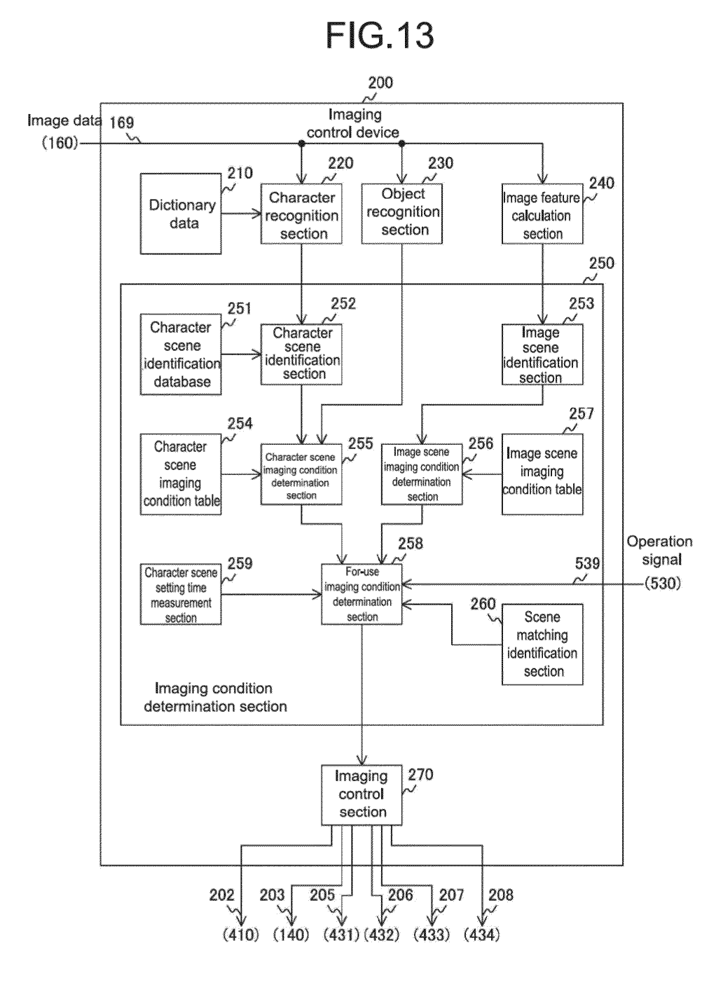

By referring to FIGS. 13 to 25, described next is a second embodiment of the present technology. FIG. 13 is a block diagram showing an exemplary configuration of the imaging control device 200 in the second embodiment. Compared with the imaging control device 200 in the first embodiment, the imaging control device 200 in the second embodiment performs imaging continuously in accordance with each of the character scene imaging conditions and the image scene imaging conditions under any fixed conditions.

The imaging condition determination section 250 in the second embodiment is additionally provided with a character scene setting time measurement section 259, and a scene matching determination table 260. Moreover, in the character scene imaging condition table 254 in the second embodiment, the character scenes each are correlated also with time conditions. The time conditions are those to be satisfied about time for use to determine whether the setting to each character scene is correctly made or not. For example, when a time setting to a character scene of wedding ceremony exceeds three hours, this setting to the character scene may be wrong because the wedding ceremony is often done within three hours. Therefore, the time conditions set to the character scene of wedding ceremony are “within three hours”. As for the imaging conditions for a character scene of beach, the time conditions set thereto are “the present time is during daytime”, e.g., from 8:00 a.m. to 6:00 p.m., because the imaging conditions therefor are determined with the assumption that imaging is performed in daytime beach.

The character scene setting time measurement section 259 measures the time for any one specific character scene set in a row. The character scene setting time measurement section 259 outputs the measurement result to the for-use imaging condition determination section 258.

The scene matching determination table 260 shows Yes or No to each combination of an image scene and a character scene about a matching therebetween.

When finding only one character scene to a character string concerned, the character scene identification section 252 in the second embodiment determines the character scene as a character scene for use. On the other hand, when finding a plurality of character scenes to the character string, the character scene identification section 252 selects any one of these character scenes as a character scene for use. For example, the character scene identification section 252 makes a selection of character scenes based on whether the character string corresponding thereto is the largest in character size. Alternatively, the for-use imaging condition determination section 258 may make a selection of character scene in accordance with a user operation similarly to the first embodiment.

The for-use imaging condition determination section 258 determines whether the time conditions for a character scene concerned are satisfied or not based on the setting time thereto, and the present time. When determining that the time conditions are not satisfied, the for-use imaging condition determination section 258 refers to the scene matching determination table 260 to determine whether there is a matching between the character scene and the image scene or not. When determining that there is no matching between the character scene and the image scene, the for-use imaging condition determination section 258 determines both the character scene imaging conditions and the image scene imaging conditions as the imaging conditions for use. When either the character scene imaging conditions or the image scene imaging conditions are determined as imaging conditions for use, the imaging control section 270 controls the imaging of the image to be performed in accordance with only the imaging conditions. On the other hand, when both of the character scene imaging conditions and the image scene imaging conditions are determined as the imaging conditions for use, the imaging control section 270 controls the imaging to be continuously performed in accordance with both of the image conditions.

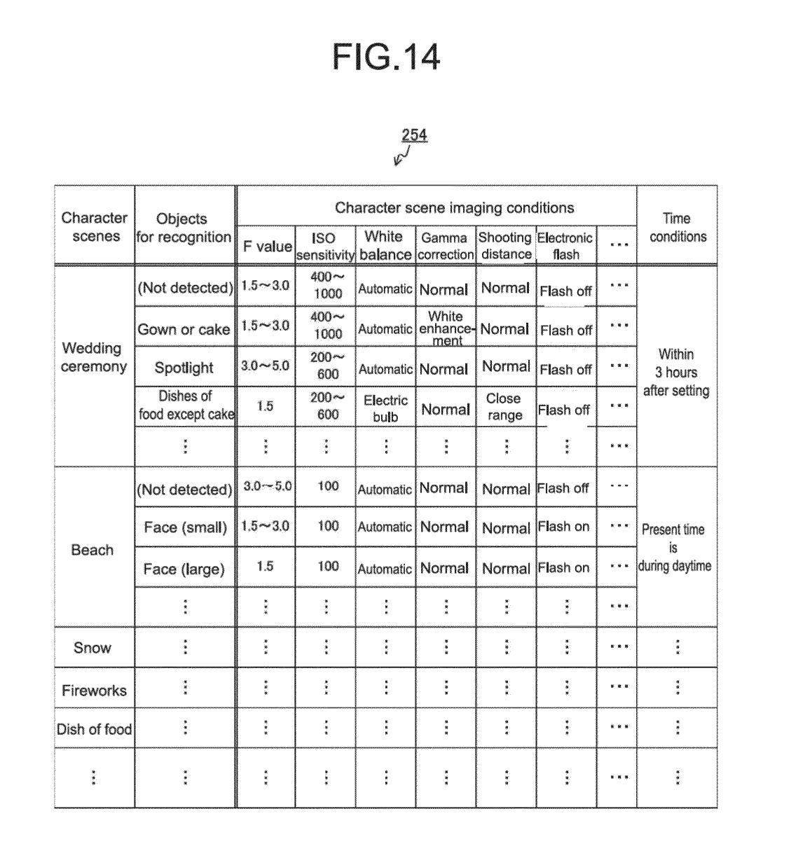

FIG. 14 is a diagram showing an exemplary configuration of the character scene imaging condition table 254 in the second embodiment. In this character scene imaging condition table 254, the time conditions are additionally set to each character scene. For example, the time conditions set to a character scene of wedding ceremony are “within three hours after setting”. For a character scene of beach, the time conditions set thereto are “the present time is during daytime”. Note that the time conditions are not restrictive to those in FIG. 14 example as long as the conditions are relevant to time. As an example, the time conditions set to the character scene of beach may be more specifically “the present time is during daytime from June to September”.

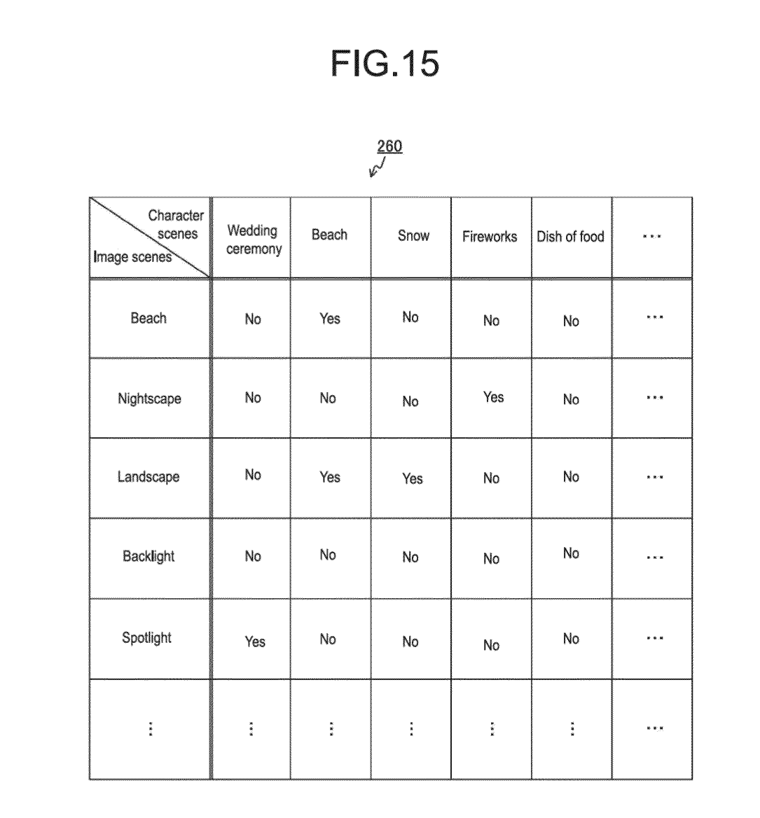

FIG. 15 is a diagram showing an exemplary configuration of the scene matching determination table 260 in the second embodiment. The scene matching determination table 260 shows, for each combination of a character scene and an image scene, Yes or No about a matching between the character scene and the image scene in the combination. In FIG. 15, “Yes” means a matching between imaging scenes, and “No” means no matching therebetween. About the matching between a character scene and an image scene, the determination factor is the similarities between the imaging conditions for each of the imaging scenes. Exemplified herein is a determination about a matching between a character scene of fireworks and an image scene of nightscape. Because imaging of fireworks is generally performed at nighttime, the imaging conditions for fireworks are much similar to those for nightscape. Therefore, a setting is so made that the character scene of fireworks and the image scene of nightscape are similar to each other.

Note that the scene matching determination table 260 is not restrictive to such a configuration, i.e., shows Yes or No about a matching between each combination of a character scene and an image scene. Alternatively, to be more specific, the table may show Yes or No about a matching between each combination of the character scene imaging conditions and the image scene imaging conditions. If this is the case, when there is no matching between the imaging conditions, the imaging control device 200 may determine both the character scene imaging conditions and the image scene imaging condition as the imaging conditions for use.

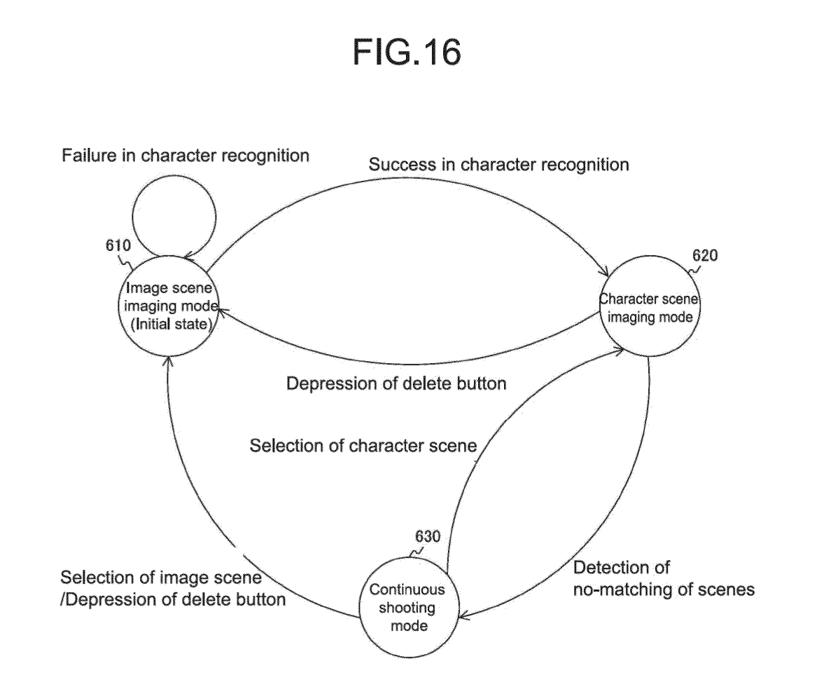

FIG. 16 is an exemplary state transition diagram of the imaging control device 200 in the second embodiment. As described above, the imaging control device 200 determines either or both of the character scene imaging conditions and the image scene imaging conditions as the imaging conditions for use. When the imaging control device 200 determines only the image scene imaging conditions as the imaging conditions for use, such a state is hereinafter referred to as “image scene imaging mode”. When the imaging control device 200 determines only the character scene imaging conditions as imaging conditions for use, such a state is hereinafter referred to as “character scene imaging mode”. When the imaging control device 200 determines both the image scene imaging conditions and the character scene imaging conditions as the imaging conditions for use, such a state is hereinafter referred to as “continuous shooting mode”.

The imaging control device 200 is set to an image scene imaging mode 610 in the initial state, for example. In this image scene imaging mode 610, the imaging control device 200 remains in the same mode if failing in recognizing a predetermined character string, and if succeeding in recognizing the character string, is changed to a character scene imaging mode 620. The imaging control device 200 in this character scene imaging mode 620 has a delete button displayed on the viewfinder 520 to cancel the character-scene settings. The imaging control device 200 then starts waiting for an operation of depressing the delete button. That is, when the portion displaying the delete button is touched by a finger or others on a touch panel used as the viewfinder 520, the imaging control device 200 accepts the operation as the operation of depressing the delete button, for example.

When the delete button is depressed in the character scene imaging mode 620, the imaging control device 200 stops producing the display of the delete button, and then is changed to the image scene imaging mode 610. When no matching of imaging scenes is detected in the character scene imaging mode 620, the imaging control device 200 is changed to a continuous shooting mode 630 with the delete button remained on the display. After performing imaging in the continuous shooting mode 630, the imaging control device 200 has a message to prompt the user to select either the character scene or the image scene displayed on the viewfinder 520, and then waits for an operation of selecting the imaging conditions. When a selection of image scenes is made after continuous shooting in the continuous shooting mode 630, the imaging control device 200 is changed to the character scene imaging mode 620. When a selection of image scenes is made after continuous shooting in the continuous shooting mode 630, or when the delete button is depressed before the continuous shooting, the imaging control device 200 is changed to the image scene imaging mode 610.

### [Exemplary Operation of Imaging Apparatus]

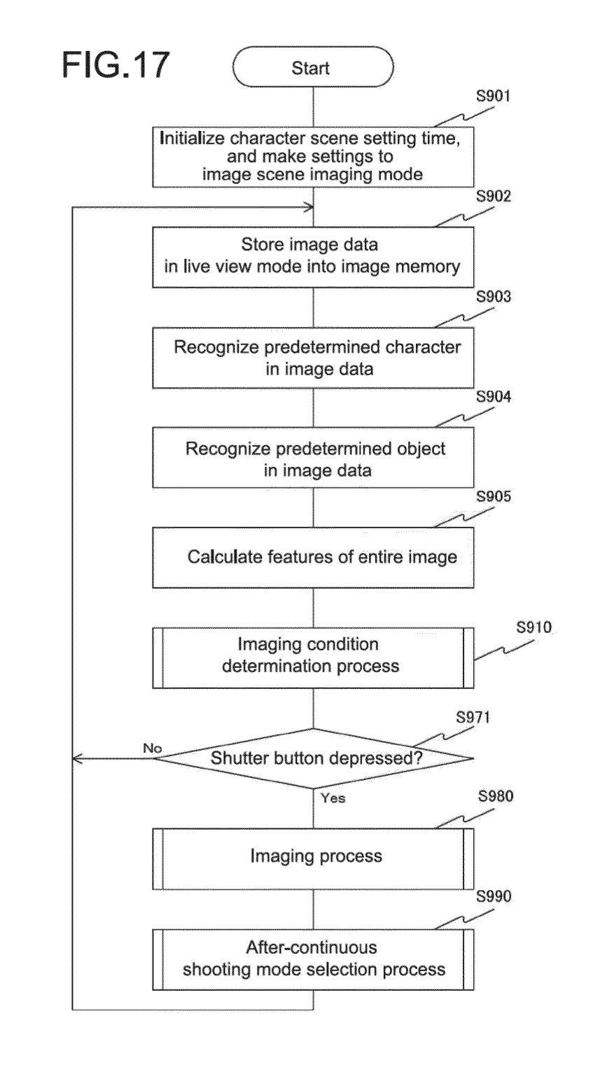

FIG. 17 is a flowchart of an exemplary operation of the imaging apparatus 100 in the second embodiment. Compared with the imaging apparatus 100 in the first embodiment, the imaging apparatus 100 in the second embodiment performs processes of steps S901, S980, and S990 as an alternative to the process of step S972.

The imaging apparatus 100 initializes the character-scene setting time in the character scene setting time measurement section 259, and sets the imaging control device 200 to be in the image scene imaging mode (step S901). The imaging apparatus 100 then performs process of steps S902 to S971. The processes in these steps are similar to those in the first embodiment. When the shutter button is depressed (step S971: Yes), the imaging apparatus 100 performs an imaging process (step S980), and then performs an after-continuous shooting mode selection process for a selection of the imaging conditions (step S990). After step S990, the procedure returns to step S902.

### [Exemplary Operation of Imaging Control Device]

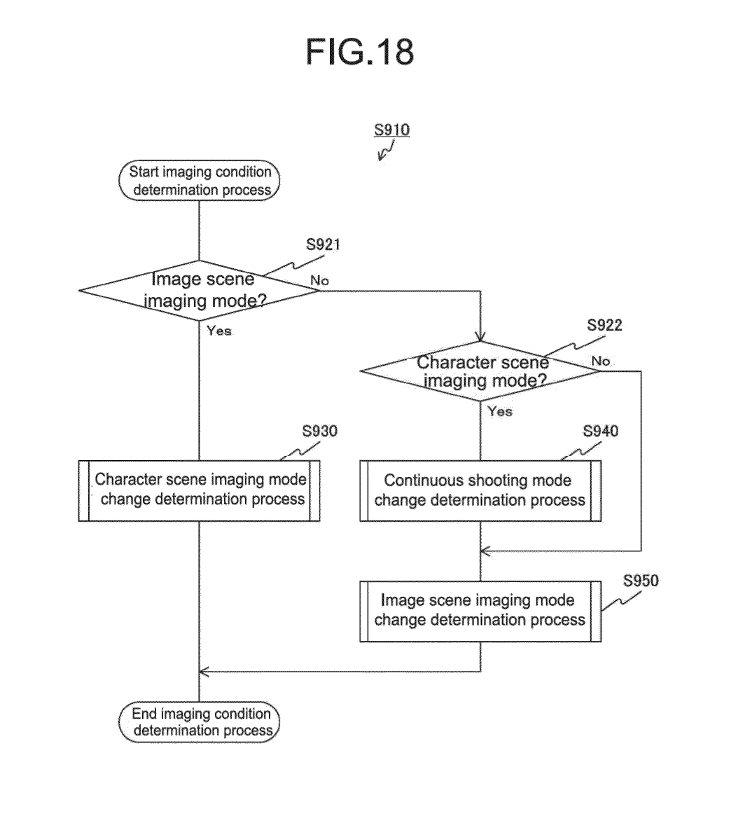

FIG. 18 is a flowchart of an exemplary imaging condition determination process in the second embodiment. The imaging control device 200 determines whether the present mode is the image scene imaging mode or not (step S921). When determining that the mode is the image scene imaging mode (step S921: Yes), the imaging control device 200 performs an after-character scene imaging mode determination process to determine whether to be in the character scene imaging mode or not (step S930).

When determining that the present mode is not the image scene imaging mode (step S921: No), the imaging control device 200 determines whether the present mode is the character scene imaging mode or not (step S922). When determining that the present mode is the character scene imaging mode (step S922: Yes), the imaging control device 200 performs a continuous shooting mode change determination process to determine whether to be in the continuous shooting mode or not (step S940). When determining that the present mode is not the character scene imaging mode, i.e., the present mode is the continuous shooting mode (step S922: No), or after step S940, the imaging control device 200 performs an image scene imaging mode change determination process (step S950). This image scene imaging mode change determination process is performed to determine whether the imaging control device 200 is to be in the image scene imaging mode or not. After step S930 or S950, this is the end of the imaging condition determination process.

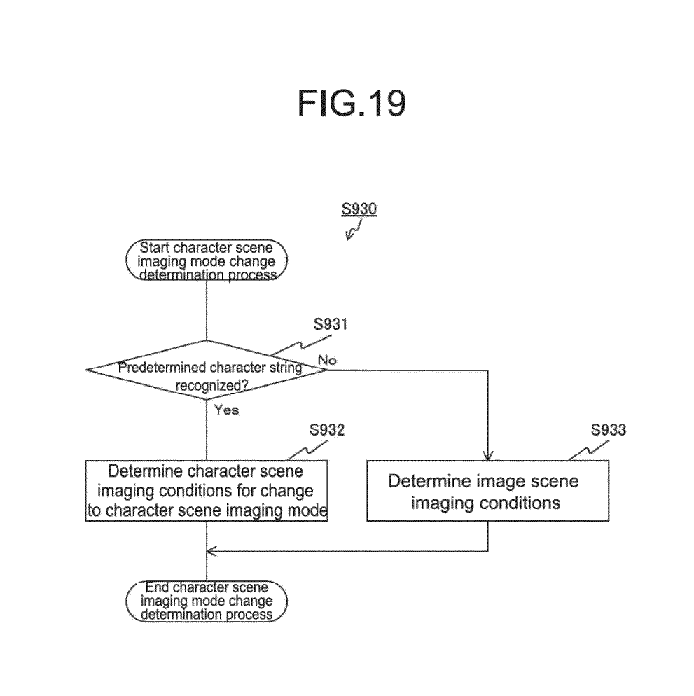

FIG. 19 is a flowchart of an exemplary character scene imaging mode change determination process in the second embodiment. The imaging control device 200 determines whether a predetermined character string is recognized or not (step S931). When determining that the predetermined character string is recognized (step S931: Yes), the imaging control device 200 determines the character scene imaging conditions corresponding to the character scene and objects relevant thereto as the imaging conditions for use, and is then changed to the character scene imaging mode. After being changed to the character scene imaging mode, the imaging control device 200 causes the viewfinder 520 to start displaying the title of the character scene corresponding to the recognized character scene, and the delete button (step S932). When determining that no character string is recognized (step S931: No), the imaging control device 200 determines the image scene imaging conditions corresponding to the image scene identified by the features as the imaging conditions for use (step S933). After step S932 or S933, this is the end of the character scene imaging mode change determination process.

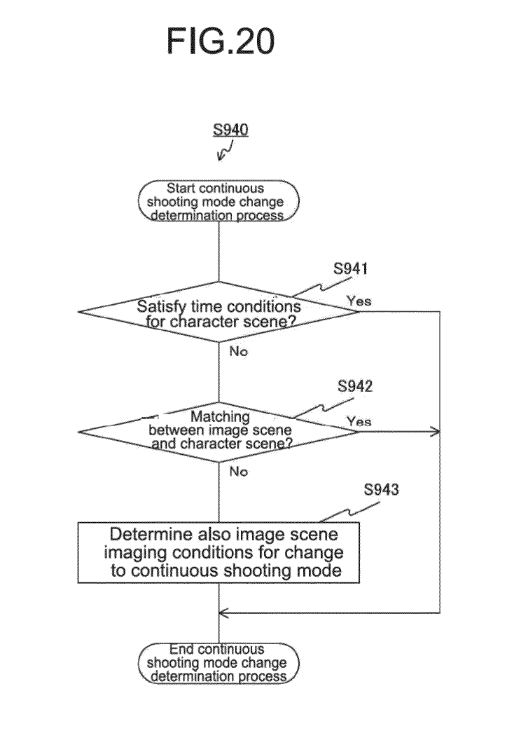

FIG. 20 is a flowchart of an exemplary continuous shooting mode change determination process in the second embodiment. The imaging control device 200 refers to the setting time of the present character scene or the present time to determine whether the time conditions for the character scene are satisfied or not (step S941). When determining that the time conditions are not satisfied (step S941: No), the imaging control device 200 refers to the scene matching determination table 260 to determine whether there is a matching between the identified image scene and the character scene or not (step S942). When determining that there is no matching between the image scene and the character scene (step S942: No), the imaging control device 200 determines the image scene imaging conditions corresponding to the image scene also as the imaging conditions for use, and is changed to the continuous shooting mode. Even after the change to the continuous shooting mode, the title of the character scene and the delete button are remained on display (step S943). When the imaging control device 200 determines that the time conditions are satisfied (step S941: Yes), when there is a matching between the image scene and the character scene (step S942: Yes), or after step S943, this is the end of the continuous shooting mode change determination process.

Herein, the imaging control device 200 is changed to the continuous shooting mode when the time conditions are not satisfied, and when there is no matching between imaging scenes. These conditions are not restrictive, and the imaging control device 200 may be changed to the continuous shooting mode in accordance with any other conditions. That is, irrespective of whether the time conditions are satisfied, the imaging control device 200 may be changed to the continuous shooting mode when there is no matching between imaging scenes, for example. Alternatively, irrespective of whether there is a matching between imaging scenes, the imaging control device 200 may be changed to the continuous shooting mode when the time conditions are not satisfied. Still alternatively, irrespective of the time conditions or a matching between imaging scenes, the imaging control device 200 may be changed to the continuous shooting mode when a character string is recognized. When the imaging control device 200 is changed to the continuous shooting mode only if a character string is recognized, the imaging control device 200 is not changed to the character scene imaging mode but only to the image scene imaging mode and the continuous shooting mode.

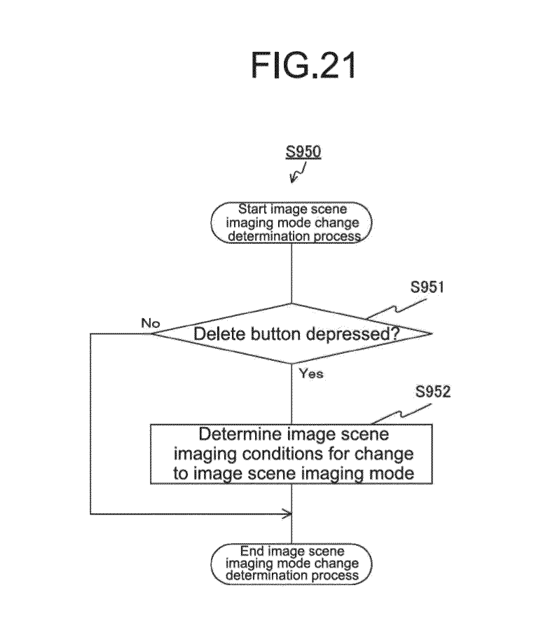

FIG. 21 is a flowchart of an exemplary image scene imaging mode change determination process in the second embodiment. The imaging control device 200 determines whether the delete button is depressed or not (step S951). When determining that the delete button is depressed (step S951: Yes), the imaging control device 200 determines the image scene imaging conditions corresponding to the image scene as the imaging conditions for use, and then is changed to the image scene imaging mode. In the image scene imaging mode, the imaging control device 200 stops producing the display of the title of the character scene and the delete button (step S952). When determining that the delete button is not depressed (step S951: No), or after step S952, this is the end of the image scene imaging mode change determination process.

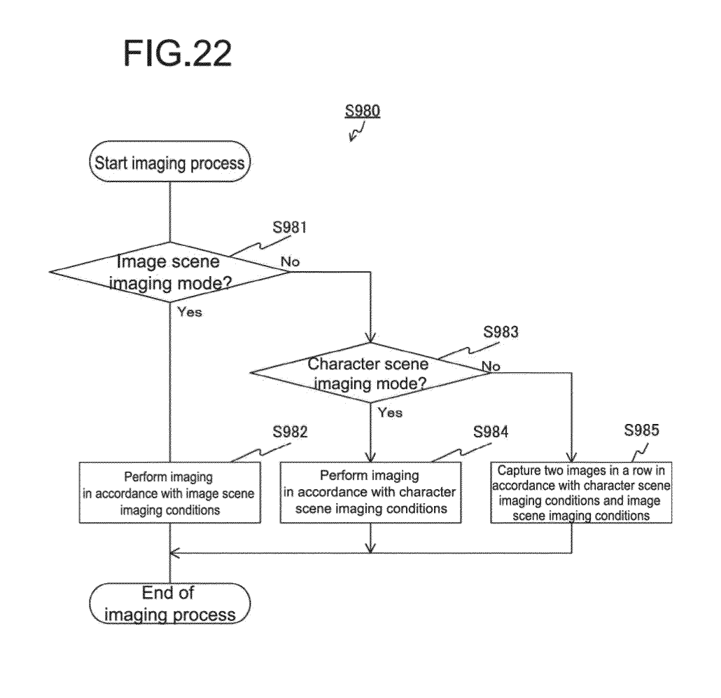

FIG. 22 is a flowchart of an exemplary imaging process in the second embodiment. The imaging apparatus 100 determines whether the imaging control device 200 is in the image scene imaging mode or not (step S981). When determining that the imaging control device 200 is in the image scene imaging mode (step S981: Yes), the imaging apparatus 100 performs imaging in accordance with the image scene imaging conditions determined as above (step S982). When determining that the imaging control device 200 is not in the image scene imaging mode (step S981: No), the imaging apparatus 100 determines whether the imaging control device 200 is in the character scene imaging mode or not (step S983). When determining that the imaging control device 200 is in the character scene imaging mode (step S983: Yes), the imaging apparatus 100 performs imaging of the image in accordance with the character scene imaging conditions determined as such (step S984). When determining that the imaging control device 200 is not in the character scene imaging mode, i.e., in the continuous shooting mode (step S983: No), the imaging apparatus 100 continuously capture two images in accordance with each of the character scene imaging conditions and the image scene imaging conditions (step S985). After steps S982, S984, or S985, this is the end of the imaging process.

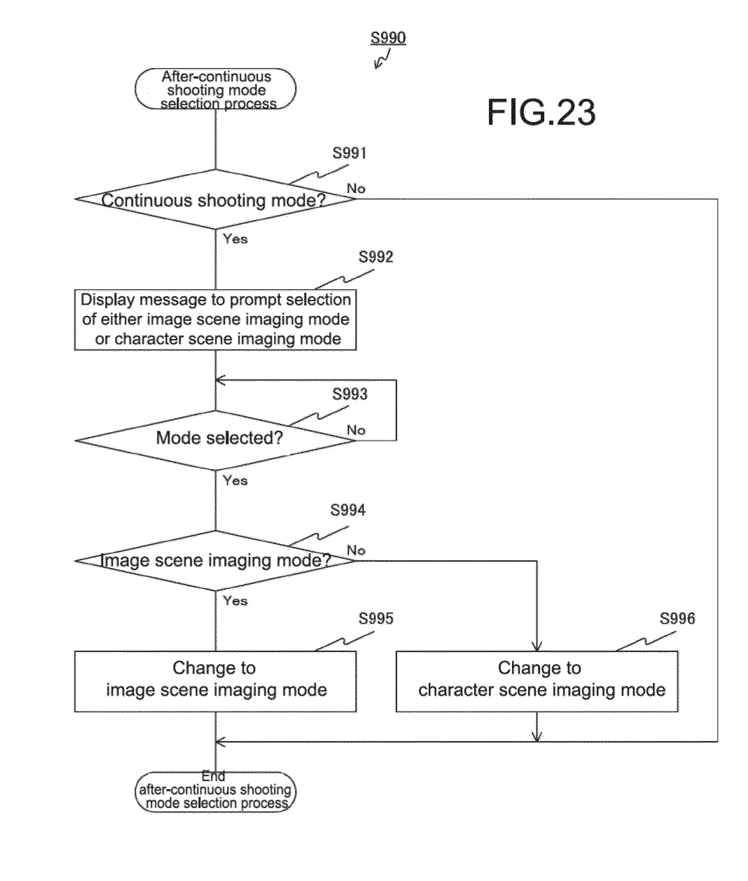

FIG. 23 is a flowchart of an exemplary after-continuous shooting mode selection process in the second embodiment. The imaging control device 200 determines whether the present mode is the continuous shooting mode or not (step S991). When determining that the present mode is in the continuous shooting mode (step S991: Yes), the imaging control device 200 causes the viewfinder 520 to display a message to prompt the user to select either the image scene imaging mode or the character scene imaging mode. That is, the imaging control device 200 displays the titles of the character and image scenes respectively corresponding to the image scene imaging mode and the character scene imaging mode, and then displays such a message to prompt the user to select either thereof, for example (step S992).

Thereafter, the imaging control device 200 waits for an operation for a mode selection, and determines whether any of the modes is selected or not (step S993). When determining that no mode is selected (step S993: No), the procedure returns to step S993. When determining that any of the modes is selected (step 993: Yes), the imaging control device 200 determines whether the selected mode is the image scene imaging mode or not (step S994). When determining that the mode is the image scene imaging mode (step S994: Yes), the imaging control device 200 is changed to the image scene imaging mode (step S995). On the other hand, when determining that the mode is the character scene imaging mode (step S994: No), the imaging control device 200 is changed to the character scene imaging mode (step S996). After being changed to the image scene imaging mode, the imaging control device 200 stops producing the display of the title of the character scene and the delete button. When determining that the mode is not the continuous shooting mode (step S991: No), or after step S995 or S996, this is the end of the after-continuous shooting mode selection process.

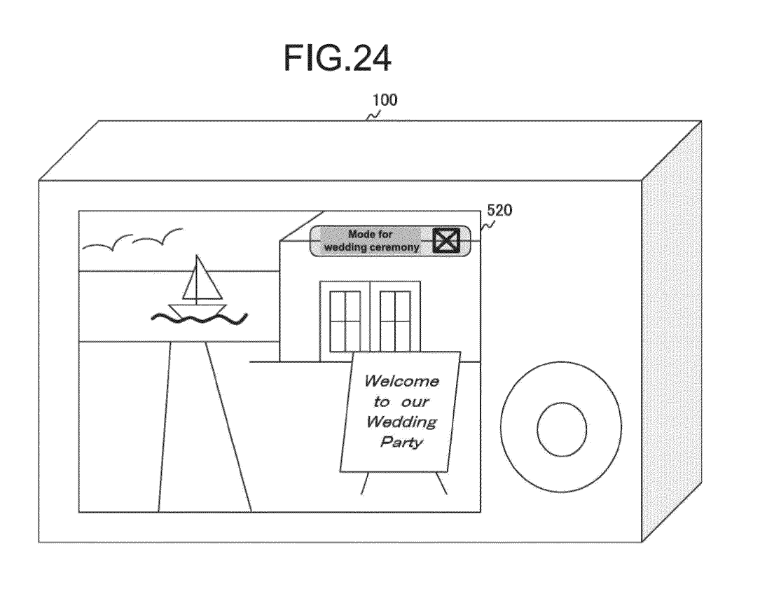

FIG. 24 is a diagram showing an exemplary image with the delete button displayed in the second embodiment. When a character string is recognized, the viewfinder 520 displays, on the upper right portion, the title of any of the character scenes corresponding to the recognized character string, and the delete button, for example. When the delete button is depressed, the imaging control device 200 is changed to the image scene imaging mode after cancelling the character-scene settings. As such, since the character-scene settings made by the imaging apparatus 100 can be cancelled with such a simple operation of depressing the delete button, the user may not feel annoyed any more even if he is asked for an image-scene setting change. When no matching of imaging scenes is detected with no depression of the delete button, the imaging control device 200 is changed to the continuous shooting mode.

In the above, the character-scene setting is cancelled by depression of the delete button displayed on the viewfinder 520, but alternatively, the character-scene setting may be cancelled by any other operation. That is, the imaging apparatus 100 may display only the character scene with no delete button on the viewfinder 520, and by operating any predetermined buttons and levers displayed not on the viewfinder 520, the character-scene setting may be cancelled.

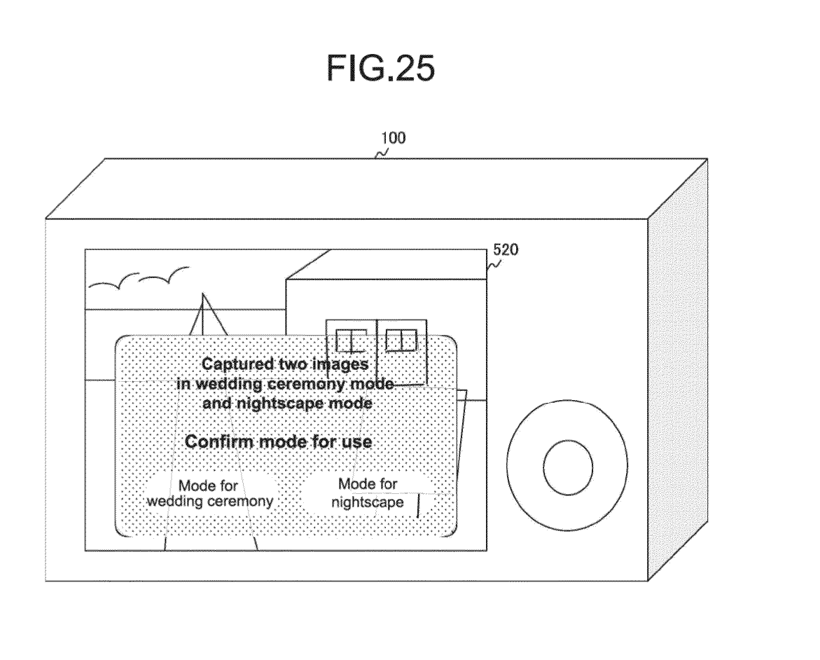

FIG. 25 is a diagram showing an exemplary image after the continuous shooting in the second embodiment. When imaging is performed continuously in accordance with the imaging conditions of a character scene of wedding ceremony and an image scene of nightscape, for example, the imaging control device 200 causes the viewfinder 520 to display a message to prompt the user to select either a scene of wedding ceremony or a scene of nightscape. When determining that the scene of wedding ceremony is selected, i.e., the character scene is selected, the imaging control device 200 is changed to the character scene imaging mode. When determining that the scene of nightscape is selected, i.e., the image scene is selected, the imaging control device 200 is changed to the image scene imaging mode.

Herein, the imaging control device 200 causes the viewfinder 520 to display a message to prompt the user to make a scene selection, but alternatively, this message may be an audio output.

As such, according to the second embodiment of the present technology, when there is no matching between a character scene and an image scene, the imaging control device 200 is changed to the continuous shooting mode in which both of the character scene imaging conditions and the image scene imaging conditions are determined as the imaging conditions for use. This does not expect the user operation to determine the imaging conditions, i.e., both the character scene imaging conditions and the image scene imaging conditions, so that the imaging is performed at the right timing in accordance with the respective imaging conditions.

While the present technology has been described in detail, the embodiments are only examples to embody the present technology, and there is a correlation between the foregoing description in the embodiments and the matters specifying the present technology in Claims. Similarly, there is a correlation between the matters specifying the present technology in Claims and the matters in the embodiments under the same notation. However, the foregoing description is in all aspects illustrative and not restrictive. It is understood that numerous other modifications and variations can be devised without departing from the scope of the present technology.

Moreover, the procedures described in the embodiments may be understood as a method including the procedures, or as a program for execution of the procedures by a computer and a recording medium storing the program. This recording medium is exemplified by a CD (Compact Disc), an MD (MiniDisc), a DVD (Digital Versatile Disk), a memory card, and a Blu-ray Disc (Trade Mark).

The present technology is also in the following structures.

(1) An imaging control device, including:

a character recognition section configured to recognize a predetermined character string in an image to be imaged;

an object recognition section configured to recognize a predetermined object in the image;

an imaging condition determination section configured to determine an imaging condition for imaging of the image, the imaging condition being determined based on the recognized character string and the recognized object; and

an imaging control section configured to control the imaging of the image in accordance with the determined imaging condition.

(2) The imaging control device according to (1), in which

the imaging condition determination section includes
a character scene identification section configured to identify an imaging scene from the recognized character string, and
a character scene imaging condition determination section configured to determine the imaging condition, the imaging condition being determined based on the identified imaging scene, and the recognized object.

(3) The imaging control device according to (2), in which

the imaging condition determination section further includes
a character scene identification database in which each candidate for the imaging scene is correlated with a candidate character string relevant thereto, and

when any of the candidate character strings is recognized, the character scene identification section identifies that the candidate corresponding to the candidate character string is the imaging scene.

(4) The imaging control device according to (2) or (3), in which

the imaging condition determination section further includes an imaging condition table in which each combination of the imaging scene and one of a plurality of objects relevant thereto is correlated with a plurality of imaging conditions, and

the character scene imaging condition determination section selects any of the imaging conditions corresponding to the combination of the identified imaging scene and the recognized object for use as the imaging condition for the imaging of the image.

(5) The imaging control device according to (4), in which

when two or more of the imaging conditions are corresponding to the combination, the character scene imaging condition determination section waits for an operation of selecting any of the imaging conditions, the selected imaging condition being determined as the imaging condition for the imaging of the image.

(6) The imaging control device according to (5), in which

when only one of the imaging conditions is corresponding to the combination, the character scene imaging condition determination section determines the imaging condition as the imaging condition for the imaging of the image without waiting for the operation.

(7) The imaging control device according to (1), in which

the imaging condition determination section includes
a character scene imaging condition determination section configured to determine a character scene imaging condition as the imaging condition, the character scene imaging condition being determined based on the recognized character string and the recognized object,
an image scene imaging condition determination section configured to determine an image scene imaging condition as the imaging condition, the image scene imaging condition being determined based on features, the features indicating a degree of predetermined features of the image in its entirety, and
a for-use imaging condition determination section configured to determine, when the character string is recognized, the character scene imaging condition as the imaging condition for the imaging of the image, and when the character string is not recognized, determine the image scene imaging condition as the imaging condition for the imaging of the image.

(8) The imaging control device according to (7), in which

the for-use imaging condition determination section determines, when the character string is recognized, the character scene imaging condition and the image scene imaging condition as the imaging condition for the imaging of the image, and

the imaging control section controls the imaging of the image based on both of the character scene imaging condition and the image scene imaging condition.

(9) The imaging control device according to (7) or (8), in which

when the character string is recognized, and when a present time is not within a predetermined time range, the for-use imaging condition determination section determines the character scene imaging condition and the image scene imaging condition as the imaging condition for the imaging of the image, and

the imaging control section controls the imaging of the image based on both the character scene imaging condition and the image scene imaging condition.

(10) The imaging control device according to any one of (7) to (9), in which

when the character string is recognized, and when the combination of the character scene imaging condition and the image scene imaging condition shows a matching with a specific combination, the for-use imaging condition determination section determines the character scene imaging condition and the image scene imaging condition as the imaging condition for the imaging of the image, and

the imaging control section controls the imaging of the image based on both the character scene imaging condition and the image scene imaging condition.

(11) The imaging control device according to any one of (7) to (10), in which

when the imaging of the image is performed in accordance with both the character scene imaging condition and the image scene imaging condition, in accordance with an operation of selecting the imaging condition, the for-use imaging condition determination section determines one of the character scene imaging condition and the image scene imaging condition as the imaging condition for imaging of an image subsequent to the image.

(12) An imaging apparatus, including:

an imaging control device including
a character recognition section configured to recognize a predetermined character string in an image to be imaged,
an object recognition section configured to recognize a predetermined object in the image,
an imaging condition determination section configured to determine an imaging condition for imaging of the image, the imaging condition being determined based on the recognized character string and the recognized object, and
an imaging control section configured to control the imaging of the image in accordance with the determined imaging condition; and

an imaging section configured to perform the imaging of the image in accordance with the control.

(13) A control method for an imaging control device, including:

recognizing, by a character recognition section, a predetermined character string in an image to be imaged;

recognizing, by an object recognition section, a predetermined object in the image;

determining, by an imaging condition determination section, an imaging condition for imaging of the image, the imaging condition being determined based on the recognized character string and the recognized object; and

controlling, by an imaging control section, the imaging of the image in accordance with the determined imaging condition.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging control device, comprising:
a character recognition section configured to recognize a predetermined character string in an image to be imaged;
an object recognition section configured to recognize a predetermined object in the image;
an imaging condition determination section configured to determine an imaging condition for imaging of the image, the imaging condition being determined based on the recognized character string and the recognized object; and
an imaging control section configured to control the imaging of the image in accordance with the determined imaging condition.

2. The imaging control device according to claim 1, wherein
the imaging condition determination section includes
a character scene identification section configured to identify an imaging scene from the recognized character string, and
a character scene imaging condition determination section configured to determine the imaging condition, the imaging condition being determined based on the identified imaging scene, and the recognized object.

3. The imaging control device according to claim 2, wherein
the imaging condition determination section further includes
a character scene identification database in which each candidate for the imaging scene is correlated with a candidate character string relevant thereto, and
when any of the candidate character strings is recognized, the character scene identification section identifies that the candidate corresponding to the candidate character string is the imaging scene.

4. The imaging control device according to claim 2, wherein
the imaging condition determination section further includes an imaging condition table in which each combination of the imaging scene and one of a plurality of objects relevant thereto is correlated with a plurality of imaging conditions, and
the character scene imaging condition determination section selects any of the imaging conditions corresponding to the combination of the identified imaging scene and the recognized object for use as the imaging condition for the imaging of the image.

5. The imaging control device according to claim 4, wherein
when two or more of the imaging conditions are corresponding to the combination, the character scene imaging condition determination section waits for an operation of selecting any of the imaging conditions, the selected imaging condition being determined as the imaging condition for the imaging of the image.

6. The imaging control device according to claim 5, wherein
when only one of the imaging conditions is corresponding to the combination, the character scene imaging condition determination section determines the imaging condition as the imaging condition for the imaging of the image without waiting for the operation.

7. The imaging control device according to claim 1, wherein
the imaging condition determination section includes
a character scene imaging condition determination section configured to determine a character scene imaging condition as the imaging condition, the character scene imaging condition being determined based on the recognized character string and the recognized object,
an image scene imaging condition determination section configured to determine an image scene imaging condition as the imaging condition, the image scene imaging condition being determined based on features, the features indicating a degree of predetermined features of the image in its entirety, and
a for-use imaging condition determination section configured to determine, when the character string is recognized, the character scene imaging condition as the imaging condition for the imaging of the image, and when the character string is not recognized, determine the image scene imaging condition as the imaging condition for the imaging of the image.

8. The imaging control device according to claim 7, wherein
the for-use imaging condition determination section determines, when the character string is recognized, the character scene imaging condition and the image scene imaging condition as the imaging condition for the imaging of the image, and
the imaging control section controls the imaging of the image based on both of the character scene imaging condition and the image scene imaging condition.

9. The imaging control device according to claim 7, wherein
when the character string is recognized, and when a present time is not within a predetermined time range, the for-use imaging condition determination section determines the character scene imaging condition and the image scene imaging condition as the imaging condition for the imaging of the image, and
the imaging control section controls the imaging of the image based on both the character scene imaging condition and the image scene imaging condition.

10. The imaging control device according to claim 7, wherein
when the character string is recognized, and when the combination of the character scene imaging condition and the image scene imaging condition shows a matching with a specific combination, the for-use imaging condition determination section determines the character scene imaging condition and the image scene imaging condition as the imaging condition for the imaging of the image, and
the imaging control section controls the imaging of the image based on both the character scene imaging condition and the image scene imaging condition.

11. The imaging control device according to claim 7, wherein
when the imaging of the image is performed in accordance with both the character scene imaging condition and the image scene imaging condition, in accordance with an operation of selecting the imaging condition, the for-use imaging condition determination section determines one of the character scene imaging condition and the image scene imaging condition as the imaging condition for imaging of an image subsequent to the image.

12. An imaging apparatus, comprising:
an imaging control device including
a character recognition section configured to recognize a predetermined character string in an image to be imaged,
an object recognition section configured to recognize a predetermined object in the image,
an imaging condition determination section configured to determine an imaging condition for imaging of the image, the imaging condition being determined based on the recognized character string and the recognized object, and
an imaging control section configured to control the imaging of the image in accordance with the determined imaging condition; and
an imaging section configured to perform the imaging of the image in accordance with the control.

13. A control method for an imaging control device, comprising:
recognizing, by a character recognition section, a predetermined character string in an image to be imaged;
recognizing, by an object recognition section, a predetermined object in the image;
determining, by an imaging condition determination section, an imaging condition for imaging of the image, the imaging condition being determined based on the recognized character string and the recognized object; and
controlling, by an imaging control section, the imaging of the image in accordance with the determined imaging condition.
